(19) United States
(12) Patent Application Publication
(10) Pub. No.: US 2026/0152608 A1
(43) Pub. Date: Jun. 4, 2026

(54) METHOD FOR MANUFACTURING OLIGOFURAN MOIETY-CONTAINING POLYCARBOSILANE AND OLIGOFURAN MOIETY-CONTAINING POLYCARBOSILANE

(71) Applicant: NATIONAL UNIVERSITY CORPORATION GUNMA UNIVERSITY, Gunma (JP)

(72) Inventors: Yuya TACHIBANA, Gunma (JP); Shunsuke BEPPU, Gunma (JP); Ken-ichi KASUYA, Gunma (JP)

(73) Assignee: NATIONAL UNIVERSITY CORPORATION GUNMA UNIVERSITY, Gunma (JP)

(21) Appl. No.: 18/714,701

(22) PCT Filed: Nov. 30, 2022
(86) PCT No.: PCT/JP2022/044086

§ 371 Date: May 30, 2024

(30) Foreign Application Priority Data
Dec. 2, 2021 (JP) 2021-196315

(51) Int. Cl. C08G 77/52

(52) U.S. Cl. CPC C08G 77/52

(57) ABSTRACT

A method of producing an oligofuran moiety-containing polycarbosilane, the method including a polymerization step of reacting a dihydrosilyloligofuran compound with a diene compound and/or diyne compound in the presence of ahydrosilylation catalyst in which method the dihydrosilyloligofuran compound being a compound having a 2- to 256-mer of a furan ring and a hydrosilyl group at the α-position of each of both terminal furan rings of the 2- to 256-mer of the furan ring.

### TECHNICAL FIELD

The present invention relates to a method of producing an oligofuran moiety-containing polycarbosilane, and an oligofuran moiety-containing polycarbosilane.

### BACKGROUND ART

Since organosilicon compounds having a π-conjugated moiety linked to the silicon element have σ-π conjugation, they have been increasingly used to develop organic semiconductor materials. Examples of such organosilicon compounds include compounds having a structure in which a thiophene ring, a benzene ring, or the like is linked.

For example, Non-Patent Document 1 reports a bithiophene moiety-containing polycarbosilane obtained by reaction of 5,5′-bis(dimethylsilyl)-2,2′-bithiophene with diallyl ether.

### PRIOR ART DOCUMENT

### Non-Patent Document

[Non-Patent Document 1] Journal of Organometallic Chemistry 696 (2011) 1236-1243

### SUMMARY OF INVENTION

### Technical Problem

In recent years, compounds having an oligofuran moiety in which a plurality of furan rings are directly linked through carbon-carbon bonds are attracting attention as new organic semiconductor materials. For example, since the most stable structure of a bifuran moiety in which two furan rings are linked through a carbon-carbon bond is the anti conformation with a dihedral angle of 180°, such a moiety is reported to have high planarity, and to be likely to show excellent semiconducting properties (see J. Phys. Chem. A 2002, 106, 15, 3823-3827 and J. Chem. Theory Comput. 2014, 10, 9, 3647-3655).

Therefore, oligofuran compounds such as bifuran compounds can be expected to be materials that are also functional as organic semiconductors. Nevertheless, no polycarbosilane having an oligofuran moiety has so far been reported.

An object of the present invention is to provide a novel method of producing an oligofuran moiety-containing polycarbosilane. Another object of the present invention is to provide a novel oligofuran moiety-containing polycarbosilane, preferably an oligofuran moiety-containing polycarbosilane having properties required for organic semiconductors or engineering plastics, such as fluorescence properties, heat resistance, or solubility that allows application to a wet process.

### Solution to Problem

As a result of intensive study to solve the above problem, the present inventors discovered that a novel polycarbosilane compound having an oligofuran moiety can be produced by reacting a dihydrosilyloligofuran compound with a diene compound and/or diyne compound, thereby completing the present invention. Specifically, the gist of the present invention is as follows.

[1] A method of producing an oligofuran moiety-containing polycarbosilane, the method comprising:
a polymerization step of reacting a dihydrosilyloligofuran compound with a diene compound and/or diyne compound in the presence of ahydrosilylation catalyst,
wherein the dihydrosilyloligofuran compound is a compound having a 2- to 256-mer of a furan ring and a hydrosilyl group at the α-position of each of both terminal furan rings of the 2- to 256-mer of the furan ring.

[2] The method of producing an oligofuran moiety-containing polycarbosilane according to [1], wherein the dihydrosilyloligofuran compound is represented by General Formula (A′-1):

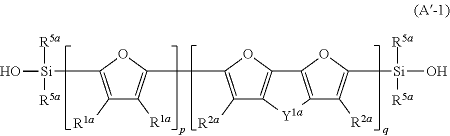

wherein R^{1a} and R^{2a} are each independently a hydrogen atom, a C₁-C₂₀ hydrocarbon group optionally having a substituent, or a C₁-C₂₀ hydrocarbonoxy group optionally having a substituent; when R^{1a} is the C₁-C₂₀ hydrocarbon group optionally having the substituent, or the C₁-C₂₀ hydrocarbonoxy group optionally having the substituent, the two R^{1a}'s bound to adjacent carbon atoms are optionally bound to each other through a direct bond or a linking group to form a ring; each R^{5a} is independently a C₁-C₂₀ hydrocarbon group optionally having a substituent, or a C₁-C₂₀ hydrocarbonoxy group optionally having a substituent; each Y^{1a} is independently —CH₂—, —CHR^{3a}—, —C(R^{3a})₂—, —PR^{3a}—, —S—, —O—, —Si(R^{3a})₂—, —NR^{3a}—, or —C═C—; each R^{3a} is independently a C₁-C₈ hydrocarbon group; p is an integer of 0 to 256; q is an integer of 0 to 128; and p+2q is an integer of 2 to 256.

[3] The method of producing an oligofuran moiety-containing polycarbosilane according to [1], wherein
the oligofuran moiety-containing polycarbosilane is a bifuran moiety-containing polycarbosilane, and
the dihydrosilyloligofuran compound is a dihydrosilylbifuran compound having a 2,2′-bifuran moiety and a hydrosilyl group at each of the 5-position and the 5′-position of the 2,2′-bifuran moiety.

[4] The method of producing an oligofuran moiety-containing polycarbosilane according to [3], wherein the dihydrosilylbifuran compound is represented by General Formula (A-1) or (A-2):

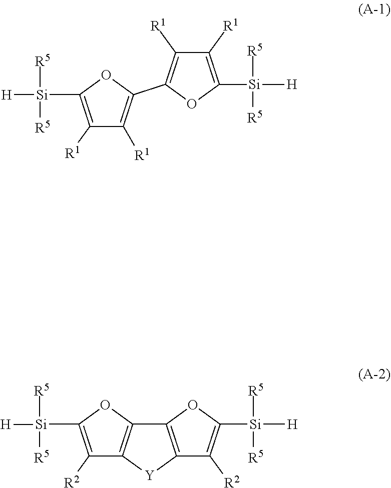

wherein R¹ and R² are each independently a hydrogen atom, a C₁-C₂₀ hydrocarbon group optionally having a substituent, or a C₁-C₂₀ hydrocarbonoxy group optionally having a substituent; when R¹ is the C₁-C₂₀ hydrocarbon group optionally having the substituent, or the C₁-C₂₀ hydrocarbonoxy group optionally having the substituent, the two R¹'s bound to adjacent carbon atoms are optionally bound to each other through a direct bond or a linking group to form a ring; each R⁵ is independently a C₁-C₂₀ hydrocarbon group optionally having a substituent, or a C₁-C₂₀ hydrocarbonoxy group optionally having a substituent; Y is —CH₂—, —CHR³—, —C(R³)₂—, —PR³—, —S—, —O—, —Si(R³)₂—, —NR³—, or —C═C—; and each R³ is independently a C₁-C₈ hydrocarbon group.

[5] The method of producing an oligofuran moiety-containing polycarbosilane according to any one of [1] to [4], wherein the diene compound is represented by General Formula (B):

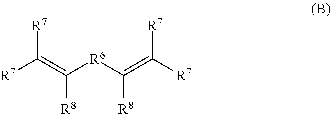

wherein R⁶ is a single bond, a C₁-C₂₀ hydrocarbon group optionally having a substituent, or —O(AO)ₙ—; AO is a C₁-C₆ alkyleneoxy group; n is an integer of 1 to 10; and R⁷ and R⁸ are each independently a hydrogen atom, a C₁-C₂₀ hydrocarbon group optionally having a substituent, or a C₁-C₂₀ hydrocarbonoxy group optionally having a substituent.

[6] The method of producing an oligofuran moiety-containing polycarbosilane according to any one of [1] to [5], wherein the diyne compound is represented by General Formula (C):

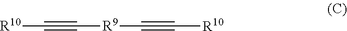

wherein R⁹ is a single bond or a C₁-C₂₀ hydrocarbon group optionally having a substituent; and each R¹⁰ is independently a hydrogen atom, a C₁-C₂₀ hydrocarbon group optionally having a substituent, or a C₁-C₂₀ hydrocarbonoxy group optionally having a substituent.

[7] An oligofuran moiety-containing polycarbosilane comprising one or more of constituent units represented by General Formulae (D′-1) to (D′-8):

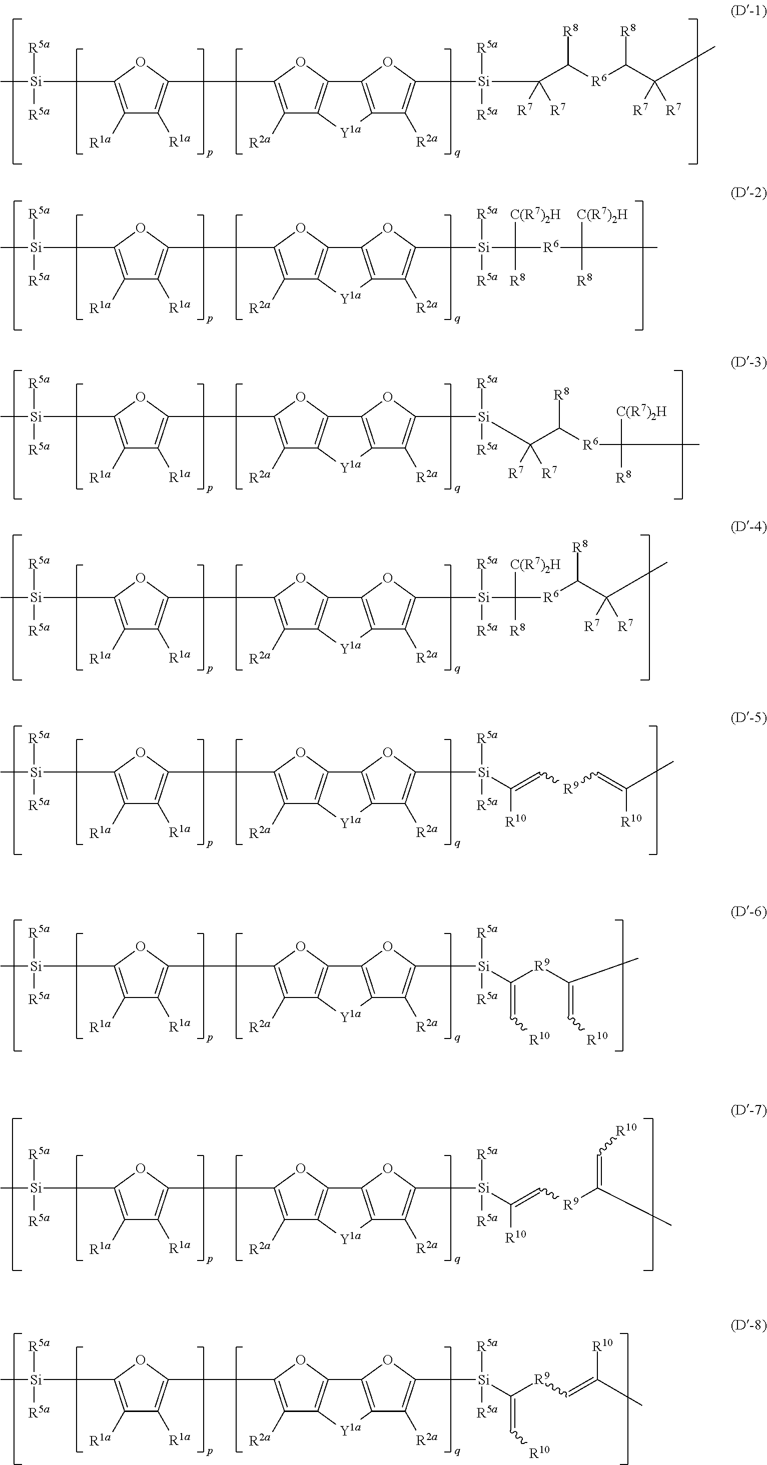

wherein R^{1a} and R^{2a} are each independently a hydrogen atom, a C₁-C₂₀ hydrocarbon group optionally having a substituent, or a C₁-C₂₀ hydrocarbonoxy group optionally having a substituent; when Ra is the C₁-C₂₀ hydrocarbon group optionally having the substituent, or the C₁-C₂₀ hydrocarbonoxy group optionally having the substituent, the two R^{1a}'s bound to adjacent carbon atoms are optionally bound to each other through a direct bond or a linking group to form a ring; each R^{5a} is independently a C₁-C₂₀ hydrocarbon group optionally having a substituent, or a C₁-C₂₀ hydrocarbonoxy group optionally having a substituent; each Y^{1a} is independently —CH₂—, —CHR^{3a}—, —C(R^{3a})₂—, —PR^{3a}—, —S—, —O—, —Si(R^{3a})₂—, —N^{3a}—, or —C═C—; each R^{3a} is independently a C₁-C₈ hydrocarbon group; p is an integer of 0 to 256; q is an integer of 0 to 128; p+2q is an integer of 2 to 256; R⁶ is a single bond, a C₁-C₂₀ hydrocarbon group optionally having a substituent, or —O(AO)ₙ—; AO is a C₁-C₆ alkyleneoxy group; n is an integer of 1 to 10; R⁷ and R⁸ are each independently a hydrogen atom, a C₁-C₂₀ hydrocarbon group optionally having a substituent, or a C₁-C₂₀ hydrocarbonoxy group optionally having a substituent; R⁹ is a single bond or a C₁-C₂₀ hydrocarbon group optionally having a substituent; and each R¹⁰ is independently a hydrogen atom, a C₁-C₂₀ hydrocarbon group optionally having a substituent, or a C₁-C₂₀ hydrocarbonoxy group optionally having a substituent.

[8] A bifuran moiety-containing polycarbosilane comprising one or more of constituent units represented by General Formulae (D-1) to (D-16):

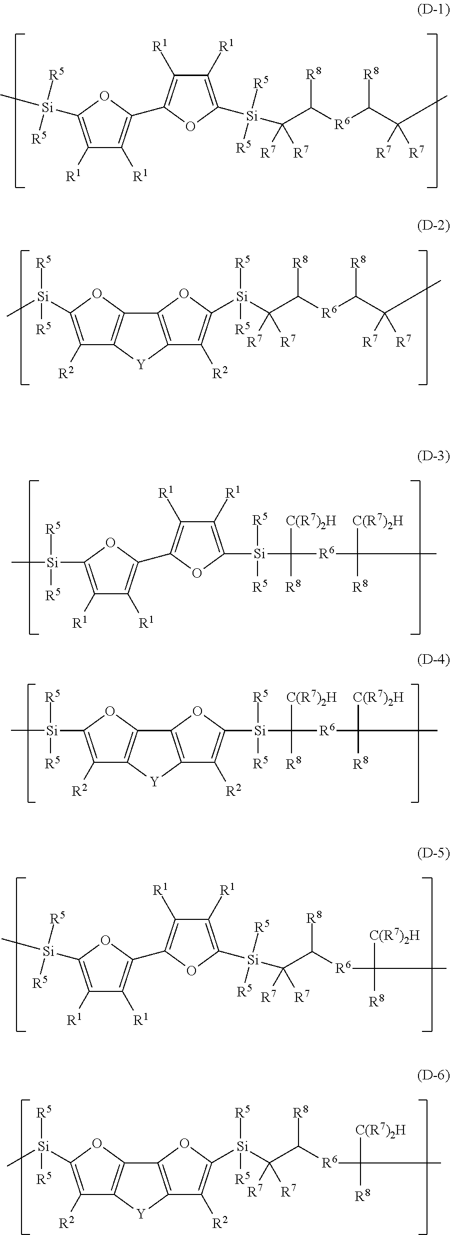

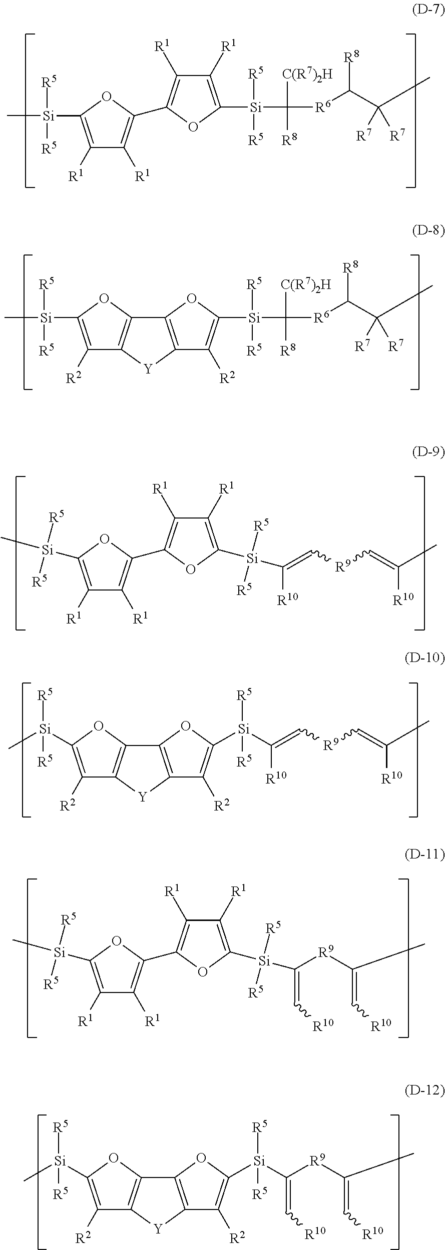

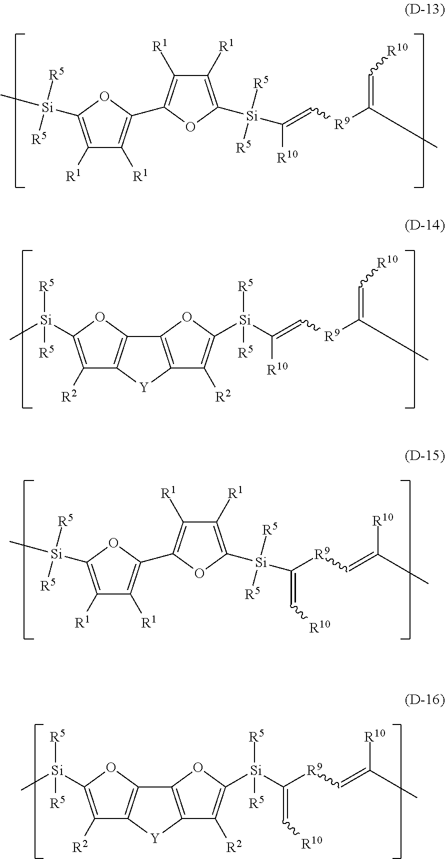

wherein R¹ and R² are each independently a hydrogen atom, a C₁-C₂₀ hydrocarbon group optionally having a substituent, or a C₁-C₂₀ hydrocarbonoxy group optionally having a substituent; when R¹ is the C₁-C₂₀ hydrocarbon group optionally having the substituent or the C₁-C₂₀ hydrocarbonoxy group optionally having the substituent, the two R¹'s bound to adjacent carbon atoms are optionally bound to each other through a direct bond or a linking group to form a ring; each R⁵ is independently a C₁-C₂₀ hydrocarbon group optionally having a substituent, or a C₁-C₂₀ hydrocarbonoxy group optionally having a substituent; Y is —CH₂—, —CHR³—, —C(R³)₂—, —PR³—, —S—, —O—, —Si(R³)₂—, —NR³—, or —C═C—; each R³ is independently a C₁-C₈ hydrocarbon group; R⁶ is a single bond, a C₁-C₂₀ hydrocarbon group optionally having a substituent, or —O(AO)ₙ—; AO is a C₁-C₆ alkyleneoxy group; n is an integer of 1 to 10; R⁷ and R⁸ are each independently a hydrogen atom, a C₁-C₂₀ hydrocarbon group optionally having a substituent, or a C₁-C₂₀ hydrocarbonoxy group optionally having a substituent; R⁹ is a single bond or a C₁-C₂₀ hydrocarbon group optionally having a substituent; and each R¹⁰ is independently a hydrogen atom, a C₁-C₂₀ hydrocarbon group optionally having a substituent, or a C₁-C₂₀ hydrocarbonoxy group optionally having a substituent.

### Advantageous Effects of Invention

The present invention can provide a novel method of producing an oligofuran moiety-containing polycarbosilane. The present invention can also provide a novel oligofuran moiety-containing polycarbosilane, preferably an oligofuran moiety-containing polycarbosilane having properties required for organic semiconductors or engineering plastics, such as fluorescence properties, heat resistance, or solubility that allows application to a wet process.

### BRIEF DESCRIPTION OF DRAWINGS

FIG. 1 is a UV spectrum and a fluorescence spectrum of the polycarbosilane obtained in Example 3-1.

FIG. 2 is a UV spectrum and a fluorescence spectrum of the polycarbosilane obtained in Example 3-2.

FIG. 3 is a UV spectrum and a fluorescence spectrum of the polycarbosilane obtained in Example 3-3.

FIG. 4 is a UV spectrum and a fluorescence spectrum of the polycarbosilane obtained in Example 3-4.

FIG. 5 is a UV spectrum and a fluorescence spectrum of the polycarbosilane obtained in Comparative Example 1.

### DESCRIPTION OF EMBODIMENTS

The present invention is described below in detail. The following descriptions of constituent features are examples (representative examples) of embodiments of the present invention, and the present invention is not limited to these contents. The present invention may be carried out with various modifications within the scope of its spirit.

### 1. Method of Producing Oligofuran Moiety-Containing Polycarbosilane

A method of producing an oligofuran moiety-containing polycarbosilane according to an embodiment of the present invention comprises a polymerization step of reacting a dihydrosilyloligofuran compound with a diene compound and/or diyne compound in the presence of a hydrosilylation catalyst. The dihydrosilyloligofuran compound is a compound having a 2- to 256-mer of a furan ring and a hydrosilyl group at the α-position of each of both terminal furan rings of the 2- to 256-mer of the furan ring. The method of producing an oligofuran moiety-containing polycarbosilane (which may be hereinafter simply referred to as “polycarbosilane”) according to the present embodiment is described below in more detail.

### 1-1. Polymerization Step

This step is a step of reacting a dihydrosilyloligofuran compound with a diene compound and/or diyne compound in the presence of ahydrosilylation catalyst.

### 1-1-1. Dihydrosilyloligofuran Compound

The dihydrosilyloligofuran compound is not limited as long as it is a compound having a 2- to 256-mer of a furan ring and a hydrosilyl group at the α-position of each of both terminal furan rings of the 2- to 256-mer of the furan ring. The dihydrosilyloligofuran compound may be appropriately selected depending on the polycarbosilane of interest. For example, when the dihydrosilyloligofuran compound is a dihydrosilylbifuran compound, the dihydrosilylbifuran compound is not limited as long as it has: a 2,2′-bifuran moiety; and a hydrosilyl group at each of the 5-position and the 5′-position of the 2,2′-bifuran moiety. The dihydrosilyloligofuran compound is a compound preferably having a 2- to 16-mer of a furan ring, more preferably having a 2- to 8-mer of a furan ring; and a hydrosilyl group at the α-position of each of both terminal furan rings thereof.

A single type of dihydrosilyloligofuran compound may be used alone, or two or more types of dihydrosilyloligofuran compounds may be used in any combination at any ratio.

Preferred examples of the dihydrosilyloligofuran compound include a compound represented by the following General Formula (A′-1). The dihydrosilyloligofuran compound can be produced by the later-described dihydrosilyloligofuran compound production step.

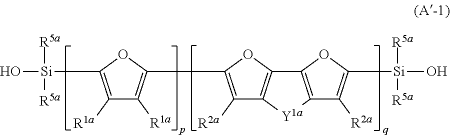

In General Formula (A′-1), R^{1a} and R^{2a} are each independently a hydrogen atom, a C₁-C₂₀ hydrocarbon group optionally having a substituent, or a C₁-C₂₀ hydrocarbonoxy group optionally having a substituent; preferably a hydrogen atom.

In the present description, examples of the hydrocarbons include aliphatic hydrocarbons and aromatic hydrocarbons. The aliphatic hydrocarbons are not limited to linear hydrocarbons, and may have a branched structure, a carbon-carbon unsaturated bond, or a cyclic structure. The aromatic hydrocarbons may be monocyclic, polycyclic, or condensed-ring aromatic hydrocarbons, or may be heterocyclic aromatic hydrocarbons.

The number described as the number of carbon atoms in the hydrocarbon group and the hydrocarbonoxy group includes the number of carbon atoms in substituents and linking groups.

When the hydrocarbon group represented by R^{1a} or R^{2a} is an aliphatic hydrocarbon group, the aliphatic hydrocarbon group is preferably a saturated aliphatic hydrocarbon group from the viewpoint of allowing the reaction with the diene compound and/or diyne compound to proceed preferentially. The number of carbon atoms in the aliphatic hydrocarbon group is usually not less than 1, and is usually not more than 20, preferably not more than 12, more preferably not more than 8, and still more preferably not more than 4. Thus, examples of a preferred range of the number of carbon atoms in the aliphatic hydrocarbon group represented by R¹ or R² include the ranges of 1 to 12, 1 to 8, and 1 to 4. When the hydrocarbon group represented by R¹ or R² is an aromatic hydrocarbon group, the number of carbon atoms in the aromatic hydrocarbon group is usually not less than 3, preferably not less than 6, and is usually not more than 20, preferably not more than 16, more preferably not more than 12. Thus, examples of a preferred range of the number of carbon atoms in the aromatic hydrocarbon group represented by R¹ or R² include the range of 3 to 16, preferably the ranges of 6 to 20, and 6 to 12.

Examples of an unsubstituted aliphatic hydrocarbon group represented by R^{1a} or R^{2a} include linear or branched saturated aliphatic hydrocarbon groups such as methyl, ethyl, n-propyl, iso-propyl, n-butyl, sec-butyl, iso-butyl, tert-butyl, n-pentyl, iso-pentyl, neopentyl, n-hexyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, 2-ethylhexyl, n-nonadecyl, and n-icosyl; and saturated aliphatic hydrocarbon groups having a cyclic structure, such as cyclopropyl, cyclobutyl, cyclopentyl, and cyclohexyl.

Examples of an unsubstituted aromatic hydrocarbon group represented by R^{1a} or R^{2a} include phenyl, 1-naphthyl, 2-naphthyl, 1-phenanthryl, 2-phenanthyl, 3-phenanthryl, 4-phenanthryl, 9-phenanthryl, 1-anthryl, 2-anthryl, 9-anthryl, 1-pyrenyl, 2-pyrenyl, 4-pyrenyl, 1-triphenylenyl, 2-triphenylenyl, 2-pyridyl, 3-pyridyl, 4-pyridyl, 2-pyrrolyl, 3-pyrrolyl, 2-thiophenylyl, 3-thiophenyl, 2-furyl, and 3-furyl.

When the hydrocarbon group represented by R^{1a} or R² has a substituent, the substituent is not limited as long as the polymerization is not inhibited. The substituent may be appropriately selected depending on the polycarbosilane of interest. The hydrocarbon group may have any number of substituents at any positions.

Examples of the substituents include a deuterium atom; C₁-C₄ alkyl groups such as methyl, ethyl, n-propyl, iso-propyl, n-butyl, sec-butyl, iso-butyl, and tert-butyl; C₃-C₆ cycloalkyl groups such as cyclopropyl, cyclobutyl, cyclopentyl, and cyclohexyl; C₆-C₁₀ aromatic hydrocarbon groups such as phenyl, 1-naphthyl, and 2-naphthyl; C₁-C₄ alkoxy groups such as methoxy, ethoxy, n-propyloxy, iso-propyloxy, n-butoxy, sec-butoxy, iso-butoxy, and tert-butoxy; inert silyl groups such as trimethylsilyl, triethylsilyl, and triphenylsilyl; cyano; cyanate; isocyanate; nitro; nitroso; and oxo.

The hydrocarbon group in the hydrocarbonoxy group represented by R^{1a} or R^{2a} has the same meaning as the hydrocarbon group represented by R^{1a} or R^{2a}, and the same preferred modes are applicable thereto.

When R^{1a} is a C₁-C₂₀ hydrocarbon group optionally having a substituent, or a C₁-C₂₀ hydrocarbonoxy group optionally having a substituent, the two R^{1a}'s bound to adjacent carbon atoms are optionally bound to each other through a direct bond or a linking group to form a ring. Examples of the linking group include, but are not limited to, —S—, —O—, —CO—, —COO—, —OCO—, —COS—, —SCO—, —CONR^{4a}—, —NR^{4a}CO—, —OCONR^{4a}—, —SO₂—, —C═C—, —C═N—, —N═C—, —N═N—, and —Si(R^{4a})₂— (wherein each R^{4a} is independently a C₁-C₈ hydrocarbon group).

R⁴ is preferably a C₁-C₈ saturated aliphatic hydrocarbon group or aromatic hydrocarbon group from the viewpoint of allowing the reaction with the diene compound and/or diyne compound to proceed preferentially.

Examples of the C₁-C₈ hydrocarbon group represented by R^{4a} include C₁-C₈ hydrocarbon groups among the hydrocarbon groups represented by R^{1a} or R^{2a}.

In General Formula (A′-1), each R^{5a} is independently a C₁-C₂₀ hydrocarbon group optionally having a substituent, or a C₁-C₂₀ hydrocarbonoxy group optionally having a substituent.

The C₁-C₂₀ hydrocarbon group optionally having a substituent, and the C₁-C₂₀ hydrocarbonoxy group optionally having a substituent, represented by Ra have the same meanings as the C₁-C₂₀ hydrocarbon group optionally having a substituent, and the C₁-C₂₀ hydrocarbonoxy group optionally having a substituent, respectively, represented by R^{1a} or R^{2a}, and the same preferred modes are applicable thereto. The four R^{5a}s in General Formula (A-1) are preferably the same group.

In General Formula (A′-1), each Y^{1a} is independently —CH₂—, —CHR^{3a}—, —C(R^{3a})₂—, —PR^{3a}—, —S—, —O—, —Si(R^{3a})₂—, —NR^{3a}— or —C═C—. Each R^{3a} is independently a C₁-C₈ hydrocarbon group.

R^{3a} is preferably a C₁-C₈ saturated aliphatic hydrocarbon group or aromatic hydrocarbon group from the viewpoint of allowing the reaction with the diene compound and/or diyne compound to proceed preferentially.

Examples of the C₁-C₈ hydrocarbon group represented by R^{3a} include C₁-C₈ hydrocarbon groups among the hydrocarbon groups represented by R^{1a} or R².

In General Formula (A′-1), p is an integer of 0 to 256, preferably an integer of 0 to 16, preferably an integer of 2 to 8. p is more preferably 2, 4, or 8.

In General Formula (A′-1), q is an integer of 0 to 128, preferably an integer of 0 to 8. q is more preferably 0, 2, or 4, still more preferably 0.

However, p+2q is an integer of 2 to 256, preferably an integer of 2 to 16, more preferably an integer of 2 to 8. p+2q is still more preferably 2, 4, or 8, especially preferably 4 or 8.

The arrangement of the p units and the q units in General Formula (A′-1) is not limited. The units may be randomly or alternately arranged, or units of the same structure may be consecutively bound.

A dihydrosilylbifuran compound as an especially preferred mode of the dihydrosilyloligofuran compound is described below in more detail. Preferred examples of the dihydrosilylbifuran compound include a dihydrosilyloligofuran compound represented by General Formula (A′-1) in which p+2q=2, which compound is represented by the following General Formula (A-1) or (A-2).

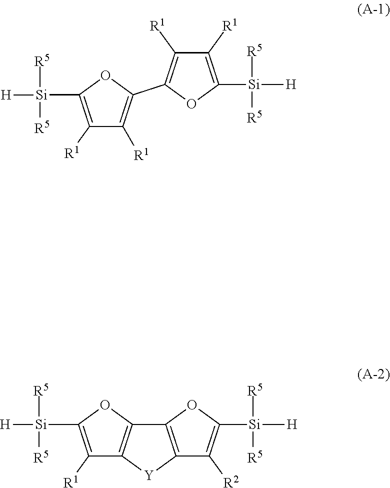

In General Formulae (A-1) and (A-2), R¹ and R² are each independently a hydrogen atom, a C₁-C₂₀ hydrocarbon group optionally having a substituent, or a C₁-C₂₀ hydrocarbonoxy group optionally having a substituent; preferably a hydrogen atom. When R¹ is a C₁-C₂₀ hydrocarbon group optionally having a substituent, or a C₁-C₂₀ hydrocarbonoxy group optionally having a substituent, the two R¹'s bound to adjacent carbon atoms are optionally bound to each other through a direct bond or a linking group to form a ring.

The C₁-C₂₀ hydrocarbon group optionally having a substituent, and the C₁-C₂₀ hydrocarbonoxy group optionally having a substituent, represented by R¹ or R² have the same meanings as the C₁-C₂₀ hydrocarbon group optionally having a substituent, and the C₁-C₂₀ hydrocarbonoxy group optionally having a substituent, respectively, represented by R^{1a} or R^{2a} in General Formula (A′-1), and the same preferred modes are applicable thereto.

When R¹ is a C₁-C₂₀ hydrocarbon group optionally having a substituent, or a C₁-C₂₀ hydrocarbonoxy group optionally having a substituent, the two R¹'s bound to adjacent carbon atoms are optionally bound to each other through a direct bond or a linking group to form a ring. The linking group has the same meaning as the linking group in the case where the R^{1a}'s in General Formula (A′-1) form a ring through a linking group, and the same preferred modes are applicable thereto.

In General Formulae (A-1) and (A-2), each R⁵ is independently a C₁-C₂₀ hydrocarbon group optionally having a substituent, or a C₁-C₂₀ hydrocarbonoxy group optionally having a substituent.

The C₁-C₂₀ hydrocarbon group optionally having a substituent, and the C₁-C₂₀ hydrocarbonoxy group optionally having a substituent, represented by R⁵ have the same meanings as the C₁-C₂₀ hydrocarbon group optionally having a substituent, and the C₁-C₂₀ hydrocarbonoxy group optionally having a substituent, respectively, represented by R^{5a} in General Formula (A′-1), and the same preferred modes are applicable thereto. The four R⁵s in General Formula (A-1) are preferably the same group. Similarly, the four R⁵s in General Formula (A-2) are preferably the same group.

In General Formulae (A-1) and (A-2), Y is —CH₂—, —CHR³—, —C(R³)₂—, —PR³—, —S—, —O—, —Si(R³)₂—, —NR³—, or —C═C—, and each R³ is independently a C₁-C₈ hydrocarbon group.

R³ is preferably a C₁-C₈ saturated aliphatic hydrocarbon group or aromatic hydrocarbon group from the viewpoint of allowing the reaction with the diene compound and/or diyne compound to proceed preferentially.

Examples of the C₁-C₈ hydrocarbon group represented by R³ include C₁-C₈ hydrocarbon groups among the hydrocarbon groups represented by R^{1a} or R^{2a} in General Formula (A′-1).

Specific examples of the dihydrosilylbifuran compound represented by General Formula (A-1) or (A-2) include the following.

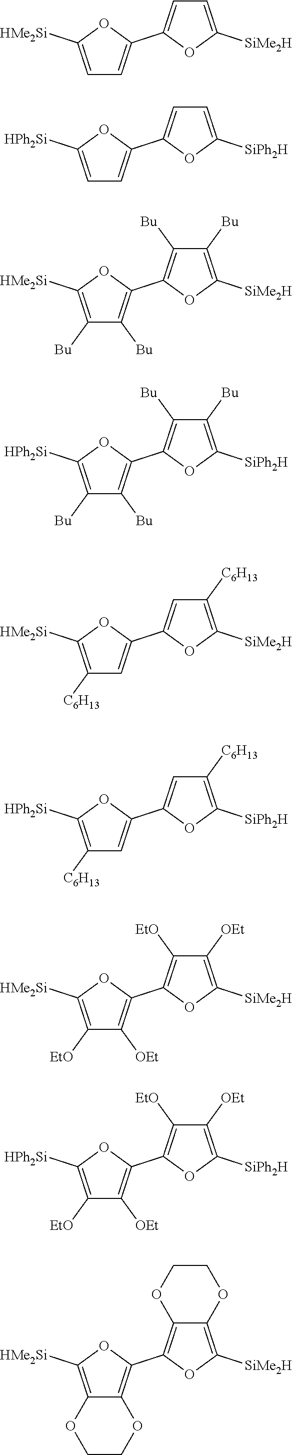

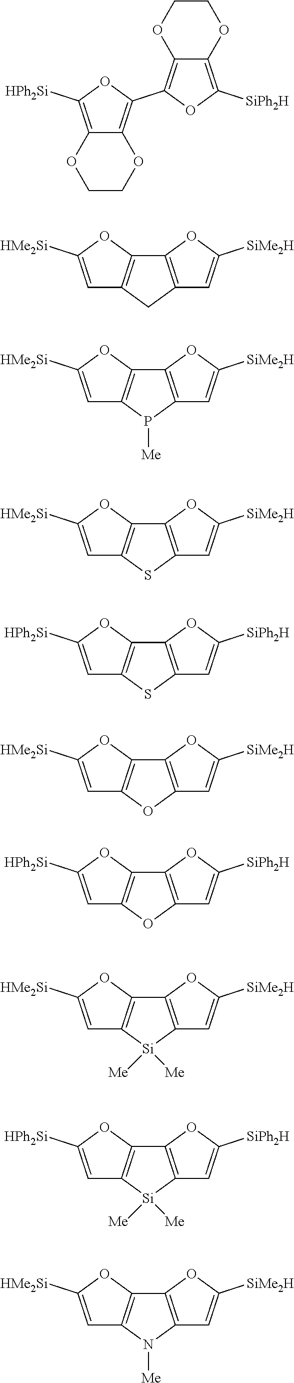

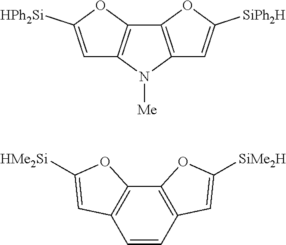

### 1-1-2. Diene Compound

The diene compound is a monomer that reacts, together with a diyne compound or alone, with a dihydrosilyloligofuran compound in the polymerization step. The diene compound is not limited as long as it is a compound having two carbon-carbon double bonds in the molecule, and may be appropriately selected depending on the polycarbosilane of interest. Preferred examples of the diene compound include a compound represented by the following General Formula (B). A single type of diene compound may be used alone, or two or more types of diene compounds may be used in any combination at any ratio. The diene compound is a known compound, or is a compound that can be easily produced by a known production method or a method similar thereto.

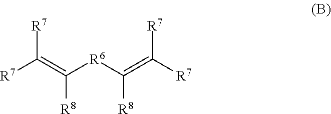

In General Formula (B), R⁶ is a single bond, a C₁-C₂₀ hydrocarbon group optionally having a substituent, or —O(AO)ₙ—; AO is a C₁-C₆ alkyleneoxy group; and n is an integer of 1 to 10.

In General Formula (B), R⁷ and R⁸ are each independently a hydrogen atom, a C₁-C₂₀ hydrocarbon group optionally having a substituent, or a C₁-C₂₀ hydrocarbonoxy group optionally having a substituent.

When the hydrocarbon group represented by R⁶ is an aliphatic hydrocarbon group, the aliphatic hydrocarbon group is preferably a saturated aliphatic hydrocarbon group from the viewpoint of allowing the reaction of interest to proceed preferentially. The number of carbon atoms in the aliphatic hydrocarbon group is usually not less than 1, and is usually not more than 20, preferably not more than 12, more preferably not more than 8, and still more preferably not more than 4. Thus, examples of a preferred range of the number of carbon atoms in the aliphatic hydrocarbon group represented by R⁶ include the ranges of 1 to 12, 1 to 8, and 1 to 4. When the hydrocarbon group represented by R⁶ is an aromatic hydrocarbon group, the number of carbon atoms in the aromatic hydrocarbon group is usually not less than 3, preferably not less than 6, and is usually not more than 20, preferably not more than 16, more preferably not more than 12. Thus, examples of a preferred range of the number of carbon atoms in the aromatic hydrocarbon group represented by R⁶ include the range of 3 to 16, preferably 6 to 20, and 6 to 12.

Examples of an unsubstituted aliphatic hydrocarbon group represented by R⁶ include a group corresponding to a linear or branched saturated aliphatic hydrocarbon such as methane, ethane, n-propane, n-butane, 2-methylpropane, n-pentane, 2-methylbutane, n-hexane, n-heptane, n-octane, n-nonane, n-decane, n-undecane, n-dodecane, n-tridecane, n-tetradecane, n-pentadecane, n-hexadecane, n-heptadecane, n-octadecane, n-nonadecane, or n-icosane from which two hydrogen atoms are excluded; and a group corresponding to a saturated aliphatic hydrocarbon having a cyclic structure such as cyclopropane, cyclobutane, cyclopentane, or cyclohexane from which two hydrogen atoms are excluded. The positions of the hydrogen atoms excluded from the saturated aliphatic hydrocarbon are not limited.

Examples of an unsubstituted aromatic hydrocarbon group represented by R⁶ include a group corresponding to an aromatic hydrocarbon such as benzene, naphthalene, phenanthrene, anthracene, pyrene, triphenylene, pyridine, pyrrole, thiophene, or furan from which two hydrogen atoms are excluded. The positions of the hydrogen atoms excluded from the aromatic hydrocarbon are not limited.

When the hydrocarbon group represented by R⁶ has a substituent, examples of the substituent that may be employed include those exemplified as substituents that may be contained in the hydrocarbon group represented by R^{1a} or R^{2a} in General Formula (A′-1).

When R⁶ is —O(AO)ₙ—, the number of carbon atoms in the alkyleneoxy group represented by AO is usually not less than 1, preferably not less than 2, and is usually not more than 6, preferably not more than 4, more preferably not more than 3. Thus, examples of a preferred range of the number of carbon atoms in the alkyleneoxy group represented by AO include the ranges of 1 to 4, 2 to 6, and 1 to 3. n is usually not less than 1, and is usually not more than 20, preferably not more than 8, more preferably not more than 6, and still more preferably not more than 4. Thus, examples of a preferred range of n include the ranges of 1 to 8, 1 to 6, and 1 to 4.

The hydrocarbon group represented by R⁷ or R⁸ and the hydrocarbon group in the hydrocarbonoxy group represented by R⁷ or R⁸ have the same meaning as the hydrocarbon group represented by R^{1a} or R^{2a} in General Formula (A′-1), and the same preferred modes are applicable thereto.

Among the above-mentioned examples, R⁷ is especially preferably a hydrogen atom, and R⁸ is preferably a hydrogen atom or methyl.

Specific examples of the diene compound represented by General Formula (B) include 1,3-butadiene, 1,4-pentadiene, 1,5-hexadiene, 2,5-dimethylhexadiene, 1,6-heptadiene, 1,7-octadiene, 1,8-nonadiene, 1,9-decadiene, 1,10-undecadiene, 1,11-dodecadiene, 1,12-tridecadiene, 1,13-tetradecadiene, 1,14-pentadecadiene, 1,15-hexadecadiene, ethylene glycol divinyl ether, diethylene glycol divinyl ether, triethylene glycol divinyl ether, propylene glycol divinyl ether, dipropylene glycol divinylether, tripropylene glycol divinyl ether, 1,2-divinylbenzene, 1,3-divinylbenzene, 1,4-divinylbenzene, 1,5-divinylnaphthalene, 2,5-divinylnaphthalene, 2,5-divinylpyridine, 2,6-divinylpyridine, 2,5-divinylthiophene, and 2,5-divinylfuran.

The amount of the diene compound used in the polymerization step is not limited, and is usually 0.9 equivalents to 1.1 equivalents with respect to the dihydrosilyloligofuran compound. From the viewpoint of increasing the molecular weight of the polycarbosilane, the amount is preferably 0.9 equivalents to 1.0 equivalent. In the polymerization step, when a diene compound and a diyne compound are used in combination, the amount of the diene compound used is preferably selected such that the total amount of the diene compound and the diyne compound used is within the range described above.

### 1-1-3. Diyne Compound

The diyne compound is a monomer that reacts, together with a diene compound or alone, with a dihydrosilyloligofuran compound in the polymerization step. The reaction between the dihydrosilyloligofuran compound and the diyne compound results in formation of a carbon-carbon double bond, and allows expansion of the σ-π conjugation between the oligofuran moiety and the silicon in the dihydrosilyloligofuran compound to the double bond, so that exertion of more favorable semiconducting properties can be expected. Therefore, as a monomer that reacts with the dihydrosilyloligofuran compound, a diyne compound is preferably used. More preferably, a diyne compound is used alone. The oligofuran moiety-containing polycarbosilane obtained by the production method according to the present embodiment shows favorable heat resistance due to the stiffness of the oligofuran moiety. By the use of the diyne compound as the monomer, formation of the carbon-carbon double bond occurs to further increase the stiffness of the main-chain moiety of the polycarbosilane, so that the heat resistance can increase further, which is preferred.

The diyne compound is not limited as long as it is a compound having two carbon-carbon triple bonds in the molecule, and may be appropriately selected depending on the polycarbosilane of interest. Preferred examples of the diyne compound include a compound represented by the following General Formula (C). A single type of diyne compound may be used alone, or two or more types of diyne compounds may be used in any combination at any ratio. The diyne compound is a known compound, or is a compound that can be easily produced by a known production method or a method similar thereto.

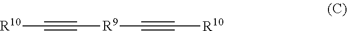

In General Formula (C), R⁹ is a single bond, or a C₁-C₂₀ hydrocarbon group optionally having a substituent.

In General Formula (C), each R¹⁰ is independently a hydrogen atom, a C₁-C₂₀ hydrocarbon group optionally having a substituent, or a C₁-C₂₀ hydrocarbonoxy group optionally having a substituent; preferably a hydrogen atom.

The hydrocarbon group represented by R⁹ has the same meaning as the hydrocarbon group represented by R⁶, and the same preferred modes are applicable thereto.

The hydrocarbon group represented by R¹⁰, and the hydrocarbon group in the hydrocarbonoxy group represented by R¹⁰ have the same meaning as the hydrocarbon group represented by R^{1a} or R^{2a} in General Formula (A′-1), and the same preferred modes are applicable thereto.

Examples of the diyne compound represented by General Formula (C) include aliphatic diynes such as 1,3-butadiyne and 1,5-hexadiyne; and aromatic diynes such as 1,2-diethynylbenzene, 1,3-diethynylbenzene, 1,4-diethynylbenzene, 1,4-diethynylnaphthalene, 2,7-diethynylnaphthalene, 2,6-diethynylpyridine, 3,5-diethynylpyridine, 2,5-diethynylthiophene, and 2,5-diethynylfuran. Among these, from the viewpoint of the expansion of the conjugation, the diyne compound is preferably an aromatic diyne.

The amount of the diyne compound used in the polymerization step is not limited, and is usually 0.9 equivalents to 1.1 equivalents with respect to the dihydrosilyloligofuran compound. From the viewpoint of increasing the molecular weight of the polycarbosilane, the amount is preferably 0.9 equivalents to 1.0 equivalent. In the polymerization step, when a diene compound and a diyne compound are used in combination, the amount of the diyne compound used is preferably selected such that the total amount of the diene compound and the diyne compound used is within the range described above.

### 1-1-4. Hydrosilylation Catalyst

The hydrosilylation catalyst used in the polymerization step is not limited as long as the hydrosilylation reaction between the dihydrosilyloligofuran compound and the diene compound and/or diyne compound can be promoted. The hydrosilylation catalyst used may be appropriately selected from known hydrosilylation catalysts.

Examples of the known hydrosilylation catalysts include platinum catalysts, palladium catalysts, rhodium catalysts, ruthenium catalysts, nickel catalysts, iron catalysts, cobalt catalysts, and boron catalysts. The hydrosilylation catalyst is preferably a catalyst selected from the Speier catalyst (PtH₂Cl₆); the Karstedt catalyst (Pt{(CH₂—CHSiMe₂)₂O}, Pt₂{(H₂C═CHSiMe₂)₂O}₃); bis(tricyclohexylphosphine)palladium(0) (Pd-PCy₃); the Wilkinson catalyst ((Ph₃P)RhCl); bis(1,5-cyclooctadiene)rhodium(I)tetrafluoroborate ([Rh(cod)₂]BF₄); bicyclo[2.2.1]hepta-2,5-diene-rhodium chloride (I) dimer ([Rh(nbd)Cl]₂); and tris(pentafluorophenyl)borane (B(C₆F₅)₃).

The hydrosilylation catalyst used may be a catalyst produced in advance. Alternatively, the hydrosilylation catalyst may be produced in the polymerization reaction system. A single type of hydrosilylation catalyst may be used alone, or two or more types of hydrosilylation catalysts may be used in any combination at any ratio as long as the reaction is not inhibited.

### 1-1-5. Solvent

The polymerization step is usually carried out in a solvent. The solvent species may be appropriately selected, for example, in accordance with the solubility of the dihydrosilyloligofuran compound, the diene compound and/or diyne compound, the oligofuran moiety-containing polycarbosilane, or the like, or with the molecular weight of the desired polycarbosilane. The solvent is preferably an anhydrous solvent from the viewpoint of suppressing a decrease in the activity of the hydrosilylation catalyst or suppressing the deactivation of the hydrosilylation catalyst. A single type of reaction solvent may be used alone, or two or more types of reaction solvents may be used in any combination at any ratio.

Preferred examples of the solvent include aromatic hydrocarbon solvents such as benzene, toluene, xylene, and mesitylene; aliphatic hydrocarbon solvents such as hexane, heptane, cyclohexane, methylcyclohexane, octane, pentane, and cyclopentane; and ether solvents such as dimethyl ether, diethyl ether, diisopropyl ether, dibutyl ether, tert-butyl methyl ether, cyclopentyl methyl ether, cyclohexyl methyl ether, anisole, 1,2-dioxane, 1,3-dioxane, 1,4-dioxane, and tetrahydrofuran (THF).

### 1-1-6. Reaction Conditions

### (Operating Procedure)

The polymerization step can be carried out, for example, by the following procedure. First, in a reactor equipped with stirring means such as a magnetic stirring bar, stirring blade, or the like, the dihydrosilyloligofuran compound, the diene compound and/or diyne compound, the hydrosilylation catalyst, and when necessary, the solvent and the like are mixed together. Subsequently, the temperature of the reaction liquid is allowed to reach a desired temperature with stirring, and then the reaction liquid is further stirred. By this, the polymerization step can be carried out.

### (Atmospheric Gas)

The polymerization step is preferably carried out in an inert atmosphere from the viewpoint of suppressing a decrease in the activity of the catalyst. Examples of the inert atmosphere include nitrogen and argon. These inert gases may be used individually, or two or more of the inert gases may be used in any combination at any ratio.

The polymerization step may be carried out under normal pressure, or may be carried out under increased pressure.

### (Reaction Temperature)

Although the reaction temperature in the polymerization step may vary depending on the type of the dihydrosilyloligofuran compound, the type(s) of the diene compound and/or diyne compound, the reaction scale, and the like, the reaction temperature is usually not less than 0° C., preferably not less than 10° C., more preferably not less than 15° C., and is usually not more than 100° C., preferably not more than 80° C., more preferably not more than 50° C. Thus, examples of a preferred range of the reaction temperature include the ranges of 0° C. to 80° C., 10° C. to 100° C., and 15° C. to 50° C.

### (Reaction Time)

The reaction time in the polymerization step is not limited, and may be appropriately adjusted in accordance with the reaction temperature, reaction scale, and the like. More specifically, after the dihydrosilyloligofuran compound, the diene compound and/or diyne compound, the hydrosilylation catalyst, and when necessary, the solvent and the like are mixed together, and then the temperature is allowed to reach a desired temperature, the reaction time is usually not less than 1 minute, preferably not less than 30 minutes, and is usually not more than 48 hours, preferably not more than 24 hours, more preferably not more than 12 hours, still more preferably not more than 6 hours. Thus, examples of a preferred range of the reaction time include the ranges of 1 minute to 24 hours, 30 minutes to 48 hours, 30 minutes to 12 hours, and 30 minutes to 6 hours.

### 1-2. Other Steps

The method of producing an oligofuran moiety-containing polycarbosilane according to the present embodiment may include not only the polymerization step, but also an optional step.

### 1-2-1. Purification Step

Examples of the optional step include a purification step for increasing the purity of the oligofuran moiety-containing polycarbosilane. As the purification step, purification methods that are normally carried out in the field of polymer synthesis, such as filtration, adsorption, and reprecipitation may be employed.

### 1-2-2. Dihydrosilyloligofuran Compound Production Step

The production method according to the present embodiment may include, as an optional step, a dihydrosilyloligofuran compound production step for producing the dihydrosilyloligofuran compound. The dihydrosilyloligofuran compound production step comprises: a deprotonation step of deprotonating an oligofuran compound in the presence of a deprotonating agent; and a hydrosilylation step of reacting the deprotonation product of the oligofuran compound with a halohydrosilane compound.

The deprotonation step is a step of abstracting the hydrogen atom (which may be hereinafter referred to as “α-position hydrogen”) bound to the carbon atom adjacent to each oxygen atom in both terminal furan rings in the oligofuran compound in the presence of a deprotonating agent. For example, when the oligofuran compound is a bifuran compound, the deprotonation step is a step of abstracting the 5-position hydrogen and the 5′-position hydrogen of the bifuran compound.

The oligofuran compound is a 2- to 256-mer, preferably a 2- to 16-mer, more preferably a 2 to 8-mer, of a furan ring. The oligofuran compound is not limited as long as it has an oligofuran moiety formed by a direct bond of carbon atoms in the 2 to 256 furan rings to each other, and has an α-position hydrogen at each of both terminal furan rings. The oligofuran compound may be appropriately selected depending on the dihydrosilyloligofuran compound of interest. For example, when the oligofuran compound is a bifuran compound in which two furan rings are linked to each other, the bifuran compound is not limited as long as it has at least the 5-position hydrogen and the 5′-position hydrogen.

A single type of oligofuran compound may be used alone, or two or more types of oligofuran compounds may be used in any combination at any ratio.

Preferred examples of the oligofuran compound include a compound represented by the following General Formula (E′-1). The oligofuran compound is a known compound, or is a compound that can be easily produced by a known production method or a method similar thereto. Examples of the known production method include the methods described in JP 2020-002103 A and WO 2012/024171.

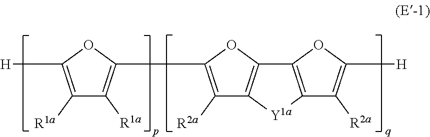

R^{1a}, R^{2a}, Y^{1a}, p, and q in General Formula (E′-1) have the same meanings as R^{1a}, R^{2a}, Y^{1a}, p, and q, respectively, in General Formula (A′-1), and the same preferred modes are applicable thereto.

A bifuran compound as an especially preferred mode of the oligofuran compound is described below in more detail. Preferred examples of the bifuran compound include an oligofuran compound represented by General Formula (E′-1) in which p+2q=2, which compound is represented by the following General Formula (E-1) or (E-2). The bifuran compound is a known compound, or is a compound that can be easily produced by a known production method or a method similar thereto. Examples of the known production method include the method described in JP 2020-002103 A

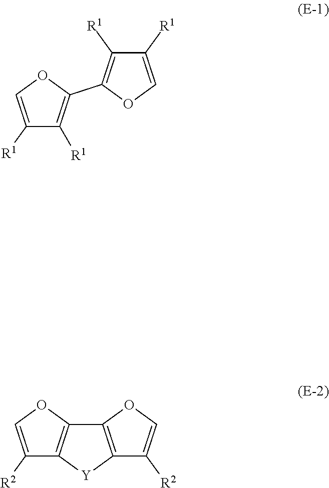

R¹ in General Formula (E-1) has the same meaning as R¹ in General Formula (A-1), and the same preferred modes are applicable thereto.

R² and Y in General Formula (E-2) have the same meanings as R² and Y, respectively, in General Formula (A-2), and the same preferred modes are applicable thereto.

Specific examples of the bifuran compound represented by General Formula (E-1) or (E-2) include the following.

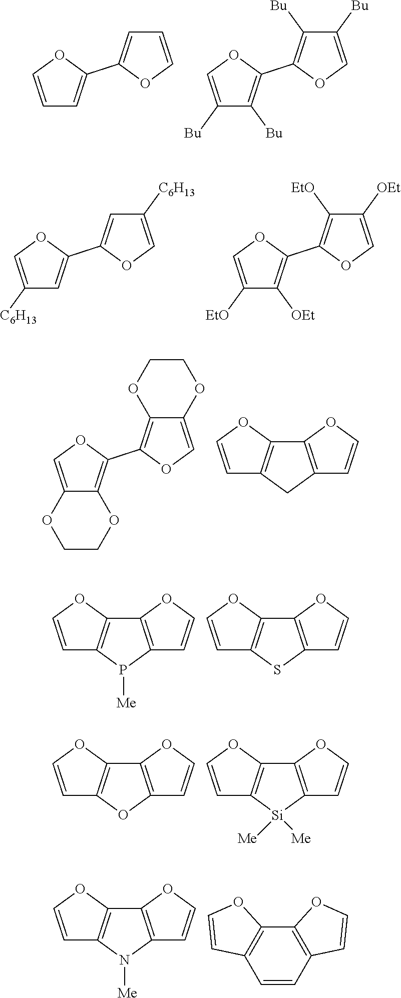

The deprotonating agent used in the deprotonation step is not limited as long as the hydrogen atom (that is, the α-position hydrogen) bound to a carbon atom adjacent to the oxygen atom in each of both terminal furan rings in the oligofuran compound can be abstracted to cause deprotonation. Examples of the deprotonating agent include an organic alkali metal compound.

Examples of the organic alkali metal compound include organolithium reagents such as ethyllithium, n-propyllithium, isopropyllithium, n-butyllithium, sec-butyllithium, tert-butyllithium, and phenyllithium. Among these, the organic alkali metal compound is preferably n-butyllithium from the viewpoint of the reactivity and the ease of handling.

A single type of deprotonating agent may be used alone, or two or more types of deprotonating agents may be used in any combination at any ratio.

The amount of the deprotonating agent used in the deprotonation step is usually not less than 2.0 equivalents, preferably not less than 2.1 equivalents, more preferably not less than 2.2 equivalents, and is usually not more than 10.0 equivalents, preferably not more than 6.0 equivalents, more preferably not more than 3.0 equivalents, with respect to the oligofuran compound as the substrate. Thus, examples of a preferred range of the amount of the deprotonating agent used with respect to the oligofuran compound include the ranges of 2.0 equivalents to 6.0 equivalents, 2.1 equivalents to 10.0 equivalents, and 2.2 equivalents to 3.0 equivalents.

In the deprotonation step, a deprotonation promoter may be used together with the deprotonating agent. The deprotonation promoter increases the basicity of the deprotonating agent, to promote the deprotonation. When the deprotonating agent is an organic alkali metal compound, a coordinating compound capable of coordination to the alkali metal atom may be used.

Examples of the coordinating compound include hexamethylphosphoramide (HMPA); dimethylpropylene urea (DMPU); tertiary amine compounds such as N,N,N′,N′-tetramethylethylenediamine (TMEDA), trimethylamine, and triethylamine; and ether compounds such as dibenzo-24-crown-8-ether, dicyclohexyl-24-crown-8-ether, 24-crown-8-ether, dibenzo-18-crown-6-ether, dicyclohexyl-18-crown-6-ether, 18-crown-6-ether, benzo-12-crown-4-ether, cyclohexyl-12-crown-4-ether, and 12-crown-4-ether. Among these, the coordinating compound is preferably selected from tetramethylethylenediamine and 12-crown-4-ether.

A single type of deprotonation promoter may be used alone, or two or more types of deprotonation promoters may be used in any combination at any ratio.

The amount of the deprotonation promoter in the deprotonation step is not limited, and may be appropriately determined depending on its coordinating ability. For example, the specific amount of the deprotonation promoter is usually not less than 0.5 equivalents, preferably not less than 0.9 equivalents, and is usually not more than 5.0 equivalents, preferably not more than 1.0 equivalent with respect to the deprotonating agent. Thus, examples of a preferred range of the amount of the deprotonation promoter used with respect to the deprotonating agent include the ranges of 0.5 equivalents to 1.0 equivalent, and 0.9 equivalents to 5.0 equivalents.

The deprotonation step is carried out usually in an anhydrous solvent in order to avoid the deactivation of the deprotonating agent.

Examples of the solvent species include aromatic hydrocarbon solvents such as benzene, toluene, xylene, and mesitylene; aliphatic hydrocarbon solvents such as hexane, heptane, cyclohexane, methylcyclohexane, octane, pentane, and cyclopentane; and ether solvents such as dimethyl ether, diethyl ether, diisopropyl ether, dibutyl ether, tert-butyl methyl ether, cyclopentyl methyl ether, cyclohexyl methyl ether, anisole, 1,2-dioxane, 1,3-dioxane, 1,4-dioxane, and tetrahydrofuran (THF). Among these, the solvent is preferably an ether solvent, more preferably tetrahydrofuran.

A single type of solvent may be used alone, or two or more types of solvents may be used in any combination at any ratio.

The deprotonation step can be carried out, for example, by the following procedure. First, the atmosphere in a reactor equipped with stirring means such as a magnetic stirring bar, stirring blade, or the like is replaced with an inert atmosphere, and then the oligofuran compound is fed into the reactor. Subsequently, the solvent, and when necessary, the deprotonation promoter is fed into the reactor, and the oligofuran compound is dissolved therein to obtain a solution. The solution is then cooled to achieve low-temperature conditions. Subsequently, while the solution is stirred under the low-temperature conditions, the deprotonating agent is added, for example, dropwise, to the solution, and then the temperature is increased when necessary, to cany out deprotonation. The reaction liquid containing a deprotonation product of the oligofuran compound, obtained by the deprotonation step may be used directly in the hydrosilylation step.

As described above, the deprotonation step is carried out in an inert atmosphere from the viewpoint of suppressing side reactions and suppressing the deactivation of the deprotonating agent. Examples of the inert atmosphere include nitrogen and argon. These inert gases may be used individually, or two or more of the inert gases may be used in any combination at any ratio.

The deprotonation step may be carried out under normal pressure, or may be carried out under increased pressure.

The reaction temperature in the deprotonation step may vary depending on the type of the oligofuran compound, the type of the deprotonating agent, the presence or absence of the deprotonation promoter, and the like. From the viewpoint of suppressing side reactions, it is preferred, as described above, to add the deprotonating agent to the solution containing the oligofuran compound under low-temperature conditions, and then to increase the temperature to continue the reaction.

Specifically, the low-temperature conditions are at usually not less than −100° C., preferably not less than −90° C., more preferably not less than −80° C., and usually not more than 70° C., preferably not more than 0° C., more preferably not more than −20° C., still more preferably not more than −50° C. Thus, preferred examples of the low-temperature conditions include those within the temperature ranges of −100° C. to 0° C., −90° C. to 70° C., −90° C. to −20° C., and −80° C. to −50° C. The temperature to be achieved by the temperature increase after the addition of the deprotonating agent is usually not less than 0° C., and is usually not more than 70° C., preferably not more than 50° C., preferably not more than 40° C., more preferably room temperature. Thus, examples of a preferred range of the temperature to be achieved by the temperature increase after the addition of the deprotonating agent include 0° C. to 70° C., 0° C. to 50° C., 0° C. to 40° C., and room temperature. In the present description, room temperature means a temperature of 15° C. to 35° C.

The reaction time in the deprotonation step is not limited, and may be appropriately adjusted in accordance with the reaction temperature, reaction scale, and the like. Specifically, the reaction time after adding the deprotonating agent to the solution containing the oligofuran compound, and increasing the temperature, is usually not less than 30 minutes, preferably not less than 1 hour, more preferably not less than 2 hours, and is usually not more than 48 hours, preferably not more than 24 hours, more preferably not more than 12 hours, still more preferably not more than 10 hours, still more preferably not more than 6 hours, especially preferably not more than 5 hours, most preferably not more than 3 hours. Thus, examples of a preferred range of the reaction time include the ranges of 30 minutes to 24 hours, 1 hour to 48 hours, 1 hour to 12 hours, 1 hour to 10 hours, 2 hours to 6 hours, 2 hours to 5 hours, and 2 hours to 3 hours.

The hydrosilylation step is a step of reacting the deprotonation product of the oligofuran compound obtained by the deprotonation step with a halohydrosilane compound, to introduce hydrosilyl groups to the oligofuran moiety.

The halohydrosilane compound used in the hydrosilylation step is not limited as long as it is a compound having a hydrosilyl group and a halosilyl group. The halohydrosilane compound may be appropriately selected depending on the dihydrosilyloligofuran compound of interest. Preferred examples of the halohydrosilane compound include a compound represented by the following General Formula (F). The halohydrosilane compound is a known compound, or is a compound that can be easily produced by a known production method or a method similar thereto.

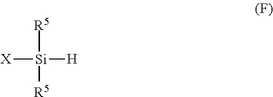

R⁵ in General Formula (F) has the same meaning as R^{5a} in General Formula (A-1), and the same preferred modes are applicable thereto.

In General Formula (F), X is a halogen atom. Examples of the halogen atom include a fluorine atom, a chlorine atom, a bromine atom, and an iodine atom. X is preferably a chlorine atom, a bromine atom, or an iodine atom, more preferably a chlorine atom or a bromine atom, still more preferably a chlorine atom.

Specific examples of the halohydrosilane compound represented by General Formula (F) include chlorodimethylsilane, chlorodiethylsilane, chloroethylmethylsilane, chlorodipropylsilane, chlorodibutylsilane, chlorodipentylsilane, chlorodihexylsilane, chlorodioctylsilane, chlorodiphenylsilane, chlorodinaphthylsilane, bromodimethylsilane, bromodiethylsilane, bromoethylmethylsilane, bromodipropylsilane, bromodibutylsilane, bromodipentylsilane, bromodihexylsilane, bromodioctylsilane, bromodiphenylsilane, bromodinaphthylsilane, iododimethylsilane, iododiethylsilane, iodoethylmethylsilane, iododipropylsilane, iododibutylsilane, iododipentylsilane, iododihexylsilane, iododioctylsilane, iododiphenylsilane, and iododinaphthylsilane.

The hydrosilylation step is carried out by adding the halohydrosilane compound to the reaction liquid obtained by the deprotonation step. Therefore, the hydrosilylation step is carried out in the solvent used for the deprotonation step.

In the hydrosilylation step, the same type of solvent as the solvent used for the deprotonation step may be further added to the reaction system. The method of the addition may be a method in which only the solvent is added to the reaction system, or may be a method in which a solution prepared by dissolving the halohydrosilane compound in the solvent is added to the reaction liquid obtained by the deprotonation step.

The hydrosilylation step can be carried out, for example, by the following procedure. First, the solution containing the deprotonation product of the oligofuran compound is cooled to achieve low-temperature conditions. Subsequently, the halohydrosilane compound is added to the obtained solution while the solution is stirred in an inert atmosphere under the low-temperature conditions, and then the temperature increases when necessary, to cany out ahydrosilylation reaction.

The hydrosilylation step is preferably carried out in an inert atmosphere from the viewpoint of suppressing protonation of the deprotonation product of the oligofuran compound and other side reactions. Examples of the inert atmosphere include nitrogen and argon. These inert gases may be used individually, or two or more of the inert gases may be used in any combination at any ratio.

From the viewpoint of the working efficiency, the hydrosilylation step is preferably carried out by feeding the halohydrosilane compound to the reactor in which the deprotonation step has been carried out. Therefore, it is also preferred to cany out the hydrosilylation step directly using the inert atmosphere in which the deprotonation step has been carried out.

The hydrosilylation step may be carried out under normal pressure, or may be carried out under increased pressure.

The reaction temperature in the hydrosilylation step may vary depending on the type of the oligofuran compound, the type of the halohydrosilane compound, the reaction scale, and the like. From the viewpoint of controlling side reactions, it is preferred, as described above, to add the halohydrosilane compound to the solution containing the oligofuran compound under low-temperature conditions, and then to increase the temperature to continue the reaction.

Specifically, the low-temperature conditions are at usually not less than −100° C., preferably not less than −90° C., more preferably not less than −80° C., and usually not more than 70° C., preferably not more than 0° C., more preferably not more than −20° C., still more preferably not more than −50° C. Thus, preferred examples of the low-temperature conditions include those within the ranges of −100° C. to 0° C., −90° C. to −70° C., −90° C. to −20° C., and −80° C. to −50° C. The temperature to be achieved by the temperature increase after the addition of the halohydrosilane compound is usually not less than 0° C., and is usually not more than 70° C., preferably not more than 50° C., more preferably not more than 40° C., still more preferably room temperature. Thus, examples of a preferred range of the temperature to be achieved by the temperature increase after the addition of the halohydrosilane compound include 0° C. to 70° C., 0° C. to 50° C., 0° C. to 40° C., and room temperature.

The reaction time in the hydrosilylation step is not limited, and may be appropriately adjusted in accordance with the reaction temperature, reaction scale, and the like. Specifically, the reaction time after adding the halohydrosilane compound to the solution containing the deprotonation product of the oligofuran compound, and increasing the temperature, is usually not less than 30 minutes, preferably not less than 1 hour, more preferably not less than 2 hours, and is usually not more than 48 hours, preferably not more than 24 hours, more preferably not more than 12 hours, still more preferably not more than 6 hours. Thus, examples of a preferred range of the reaction time include the ranges of 30 minutes to 24 hours, 1 hour to 48 hours, 1 hour to 12 hours, and 2 hours to 6 hours.

### 1-4. Oligofuran Moiety-Containing Polycarbosilane

The oligofuran moiety-containing polycarbosilane produced by the production method according to the present embodiment is not limited as long as it is obtained through the polymerization step. It is preferably a polycarbosilane obtained using a compound represented by General Formula (A′-1) as the dihydrosilyloligofuran compound, and using a compound represented by General Formula (B) and/or a compound represented by General Formula (C) as the diene compound and/or diyne compound. Such a polycarbosilane has one or more of constituent units represented by General Formulae (D′-1) to (D′-8).

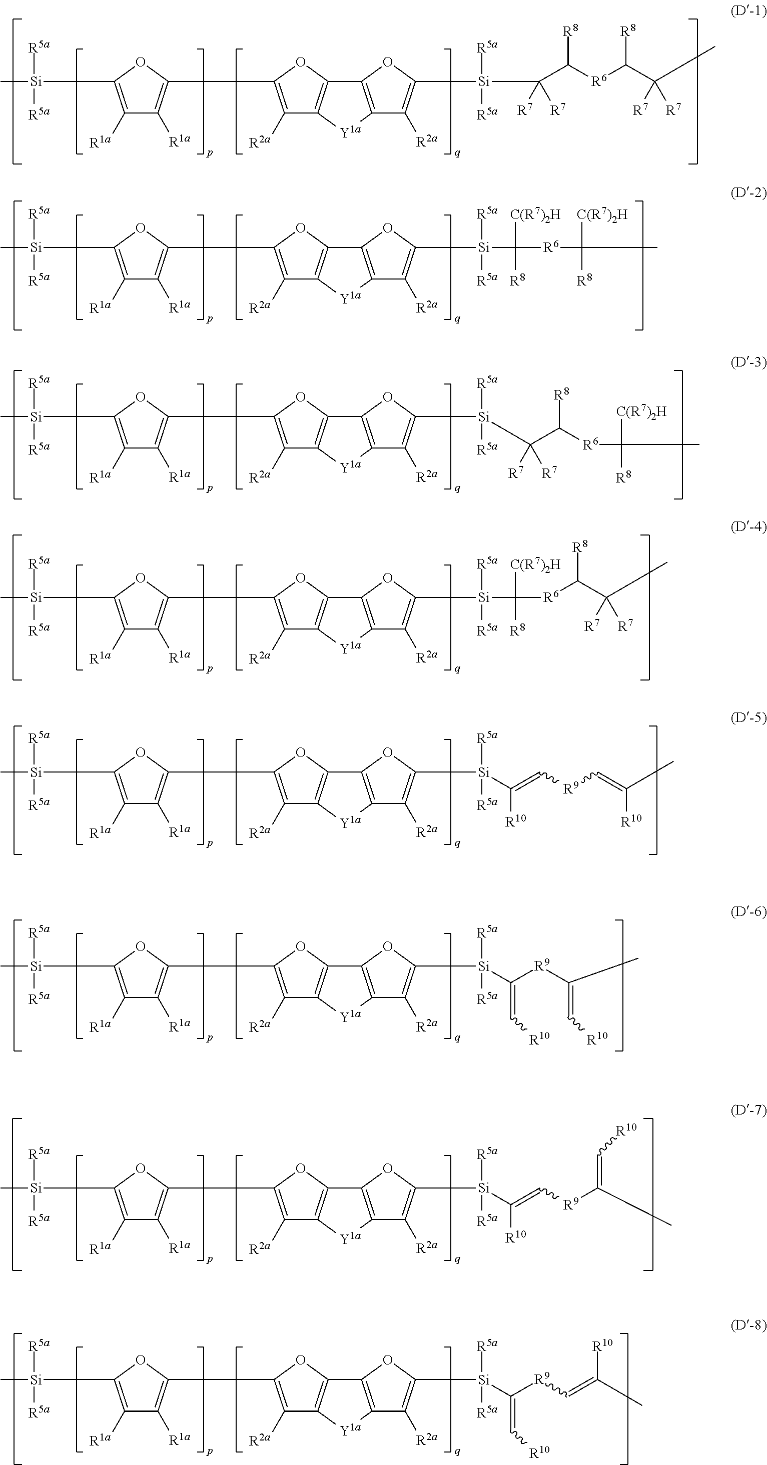

R^{1a}, R^{2a}, R^{5a}, Y^{1a}, p, and q in General Formulae (D′-1) to (D′-4) have the same meanings as R^{1a}, R^{2a}, R^{5a}, Y^{1a}, p, and q, respectively, in General Formula (A′-1), and the same preferred modes are applicable thereto.

R⁶ to R⁸ in General Formulae (D′-1) to (D′-4) have the same meanings as R⁶ to R⁸, respectively, in General Formula (B), and the same preferred modes are applicable thereto.

R^{1a}, R^{2a}, R^{5a}, Y^{1a}, p, and q in General Formulae (D′-5) to (D′-8) have the same meanings as R^{1a}, R^{2a}, R^{5a}, Y^{1a}, p, and q, respectively, in General Formula (A′-1), and the same preferred modes are applicable thereto.

R⁹ and R¹⁰ in General Formulae (D′-5) to (D′-8) have the same meanings as R⁹ and R¹⁰, respectively, in General Formula (C), and the same preferred modes are applicable thereto.

Among these, an especially preferred polycarbosilane is a polycarbosilane obtained using a dihydrosilylbifuran compound represented by General Formula (A-1) or (A-2) as the dihydrosilyloligofuran compound, and using a compound represented by General Formula (B) and/or a compound represented by General Formula (C) as the diene compound and/or diyne compound. Such a polycarbosilane has one or more of constituent units represented by General Formulae (D-1) to (D-16).

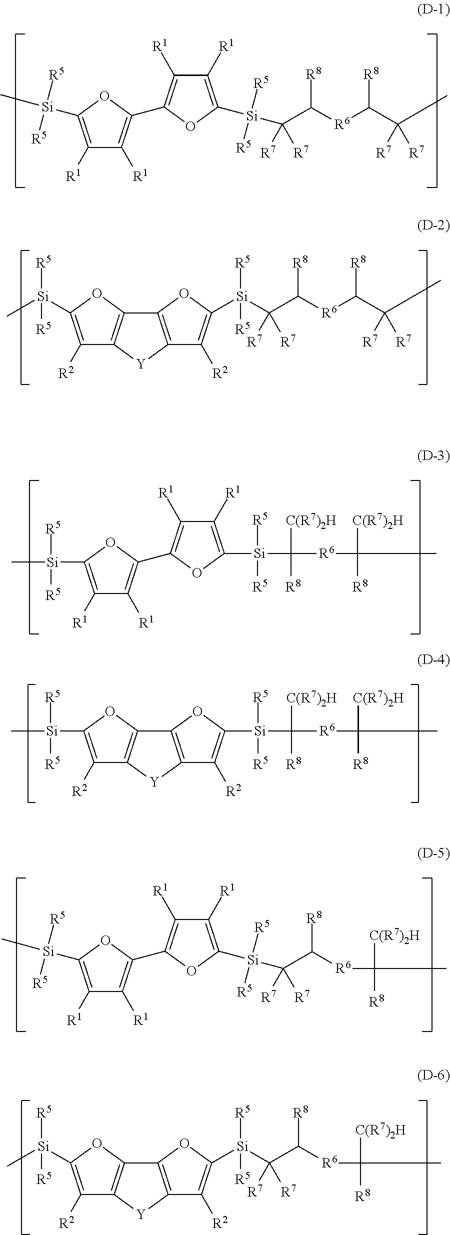

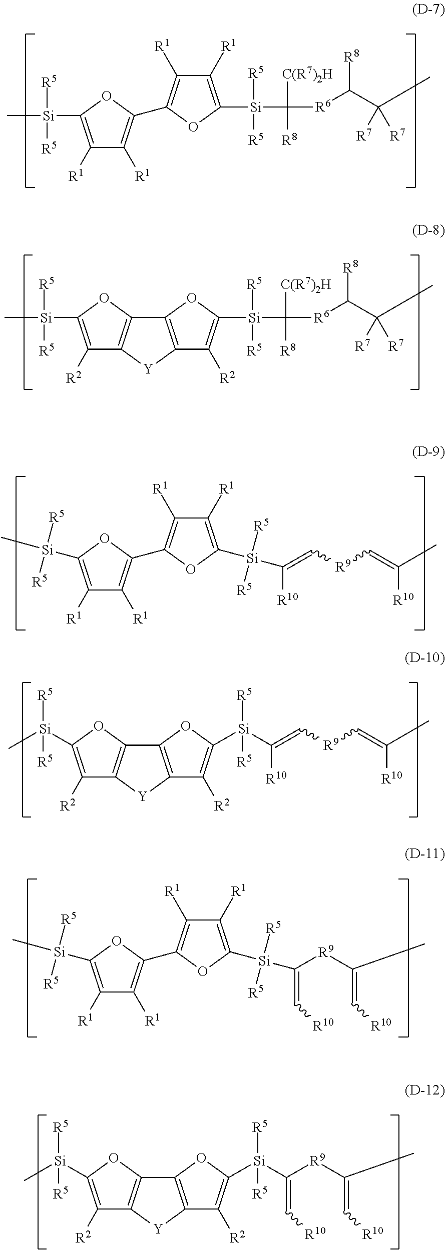

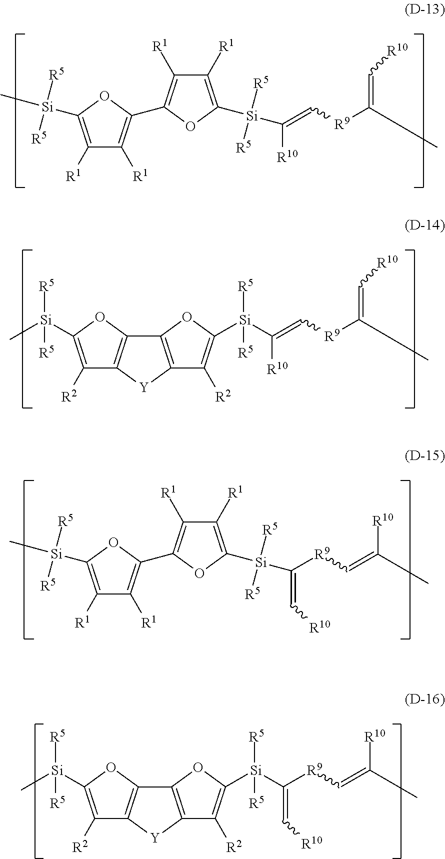

R¹ and R⁵ in General Formulae (D-1), (D-3), (D-5), and (D-7) have the same meanings as R¹ and R⁵, respectively, in General Formula (A-1), and the same preferred modes are applicable thereto.

R⁶ to R⁸ in General Formulae (D-1), (D-3), (D-5), and (D-7) have the same meanings as R⁶ to R⁸, respectively, in General Formula (B), and the same preferred modes are applicable thereto.

R², R⁵, and Y in General Formulae (D-2), (D-4), (D-6), and (D-8) have the same meanings as R², R⁵, and Y, respectively, in General Formula (A-2), and the same preferred modes are applicable thereto.

R⁶ to R⁸ in General Formulae (D-2), (D-4), (D-6), and (D-8) have the same meanings as R⁶ to R⁸, respectively, in General Formula (B), and the same preferred modes are applicable thereto.

R¹ and R⁵ in General Formulae (D-9), (D-11), (D-13), and (D-15) have the same meanings as R¹ and R⁵, respectively, in General Formula (A-1), and the same preferred modes are applicable thereto.

R⁹ and R¹⁰ in General Formulae (D-9), (D-11), (D-13), and (D-15) have the same meanings as R⁹ and R¹⁰, respectively, in General Formula (C), and the same preferred modes are applicable thereto.

R², R⁵, and Y in General Formulae (D-10), (D-12), (D-14), and (D-16) have the same meanings as R², R⁵, and Y, respectively, in General Formula (A-2), and the same preferred modes are applicable thereto.

R⁹ and R¹⁰ in General Formulae (D-10), (D-12), (D-14), and (D-16) have the same meanings as R⁹ and R¹⁰, respectively, in General Formula (C), and the same preferred modes are applicable thereto.

The number average molecular weight (Mₙ) of the oligofuran moiety-containing polycarbosilane obtained by the production method according to the present embodiment is not limited. Regarding the lower limit, Mₙ is preferably not less than 1.5×10³, more preferably not less than 2.0×10³, still more preferably not less than 2.5×10³, and may be not less than 3.0×10³, not less than 5.0×10³, not less than 10×10³, or not less than 15×10³. The upper limit of the number average molecular weight (Mₙ) of the oligofuran moiety-containing polycarbosilane is not limited. Mₙ is usually not more than 1000×10³ and may be not more than 500×10³, not more than 100×10³, not more than 50×10³, not more than 20×10³, or not more than 10×10³. Thus, examples of a preferred range of the number average molecular weight (Mₙ) of the oligofuran moiety-containing polycarbosilane include the ranges of 1.5×10³ to 1000×10³, 2.0×10³ to 500×10³, 2.5×10³ to 100×10³, 3.0×10³ to 50×10³, 5.0×10³ to 10×10³, 10×10³ to 20×10³, and 15×10³ to 20×10³. The number average molecular weight (Mₙ) of the polycarbosilane can be adjusted by the reaction solvent, the reaction temperature, the monomer concentration, and the like.

The polydispersity (M_{w}/Mₙ) of the oligofuran moiety-containing polycarbosilane obtained by the production method according to the present embodiment is not limited. It is usually not less than 1.0, and may be not less than 1.1, not less than 1.2, or not less than 1.5. It is usually not more than 5.0, preferably not more than 2.5, more preferably not more than 2.0. Thus, examples of a preferred range of the polydispersity (M_{w}/Mₙ) of the oligofuran moiety-containing polycarbosilane include the ranges of 1.0 to 2.5, 1.1 to 5.0, 1.2 to 2.0, and 1.5 to 2.0. The polydispersity (M_{w}/Mₙ) of the polycarbosilane can be adjusted by the reaction solvent, the reaction temperature, and the like.

As described in the Examples below, the number average molecular weight (Mₙ) and the weight average molecular weight (M_{w}) of the oligofuran moiety-containing polycarbosilane are calculated from a chromatogram obtained by gel permeation chromatography (GPC), using a calibration curve obtained with standard polystyrene. The GPC measurement is carried out using, for example, the “LC-4000 System”, manufactured by JASCO Corporation, and a chloroform solvent as the solvent.

### EXAMPLES

The present invention is described below more concretely by way of Examples. However, the present invention may be modified as appropriate within the spirit of the present invention. Accordingly, the scope of the present invention should not be interpreted as being limited by the following specific examples.

Measurement of the number average molecular weight (Mₙ) and the weight average molecular weight (M_{w}) of each polycarbosilane obtained in Examples was carried out by the following method.

[Method of Measuring Number Average Molecular Weight (Mₙ) and Weight Average Molecular Weight (M_{w})]

A polymer was dissolved in chloroform to prepare a solution at 1.0 mg/mL, and then the solution was filtered through a membrane filter with a pore size of 0.45 μL, to obtain a sample.

Using the sample obtained, the number average molecular weight (Mₙ) was measured by GPC (gel permeation chromatography). The measurement was carried out using the “LC-4000 System” manufactured by JASCO Corporation, as the GPC apparatus, and chloroform as the solvent. The measurement was carried out under conditions at a flow rate of 1.0 mL/min and a temperature of 40° C. For the preparation of a calibration curve, standard polystyrenes manufactured by Tosoh Corporation (number average molecular weights=2.89×10⁶, 7.06×10⁵, 3.55×10⁵, 9.64×10⁴, 3.79×10⁴, 1.02×10⁴, 2.63×10³, and 4.33×10²) were used.

### Synthesis Example: Synthesis of Dihydrosilylbifuran Compound

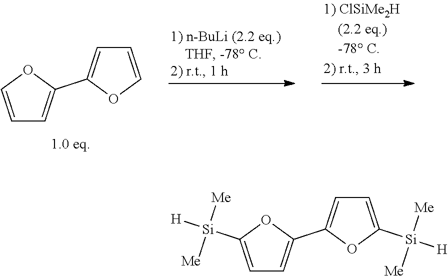 [SMILES: c1coc(-c2ccco2)c1 ; C[SiH](C)c1ccc(-c2ccc([SiH](C)C)o2)o1]

To a 50-mL Schlenk tube in which the atmosphere was replaced with nitrogen, 2,2′-bifuran (0.62 g, 4.6 mmol) and anhydrous tetrahydrofuran (30 mL) were added, and the resulting mixture was stirred at −78° C. for 30 minutes. To the 2,2′-bifuran solution obtained, a solution of n-butyllithium in hexane (2.69 M, 3.8 mL, 10 mmol) was added dropwise, and the resulting mixture was stirred at −78° C. for 30 minutes. Thereafter, the reaction liquid was allowed to warm to room temperature and stirred for 1 hour to cany out deprotonation.

Subsequently, the reaction liquid obtained by the deprotonation was cooled to −78° C. with stirring, and chlorodimethylsilane (0.87 mL, 10 mmol) was added dropwise thereto. Thereafter, the reaction liquid was allowed to warm to room temperature and stirred for 3 hours to cany out silylation.

Water and hexane were added to the resulting reaction mixture, and the organic layer was extracted. The resulting extract was washed with saturated brine, and dried over anhydrous sodium sulfate, followed by evaporating the solvent under reduced pressure, to obtain a red solid as a crude product. The crude product was purified by Kugelrohr distillation, to obtain 5,5′-bis(dimethylsilyl)-2,2′-bifuran as a white solid (0.77 g; yield, 67%).

### Example 1: Study of Reaction Time

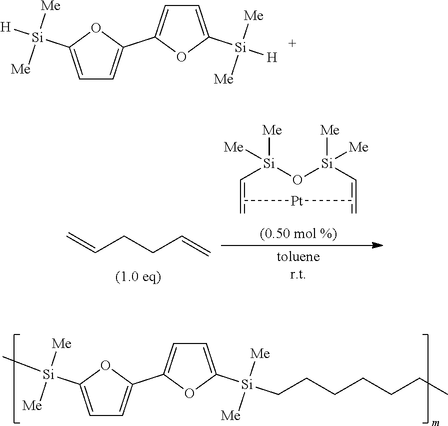

To a Schlenk tube (30 mL) in which the atmosphere was replaced with nitrogen, a 1,3-divinyl-1,1,3,3-tetramethyldisiloxane platinum(0) complex solution (1.9 μL, 5.0 μmol), toluene (3.0 mL), the 5,5′-bis(dimethylsilyl)-2,2′-bifuran obtained in Synthesis Example (0.25 g, 1.0 mmol), and 1,5-hexadiene (0.12 mL, 1.0 mmol) were placed, and polymerization reaction was carried out with stirring at room temperature. Thereafter, changes in the number average molecular weight (M_{w}) and the polydispersity (M_{w}/Mₙ) of the polycarbosilane were measured over time during the reaction. The results are shown in Table 1.

TABLE 1

| Reaction Time (h) | Mₙ | M_{w}/Mₙ |
|---|---|---|
| 1 | 1.9 × 10³ | 2.0 |
| 2 | 2.0 × 10³ | 2.1 |
| 4 | 1.5 × 10³ | 2.5 |
| 8 | 1.8 × 10³ | 2.1 |
| 24 | 1.7 × 10³ | 2.2 |
| 48 | 1.6 × 10³ | 2.2 |

No significant change in the number average molecular weight (M_{w}) or the polydispersity (M_{w}/Mₙ) was found as a result of the changes in the reaction time. Thus, according to Table 1, the polymerization reaction was found to have proceeded over a period of as short as about 1 hour.

### Example 2-1 to Example 2-4: Study of Reaction Solvent

Polycarbosilane was obtained in the same manner as in Example 1 except that the solvent shown in Table 2 was used as the reaction solvent, and that the reaction time was 1 hour. After the reaction, the solvent was distilled off from the resulting reaction mixture, to obtain a viscous crude product. The crude product was dissolved in toluene, and the resulting solution was added dropwise to methanol, to allow reprecipitation. The resulting precipitate was collected by filtration, and dried under vacuum at 30° C., to obtain polycarbosilane as a granular pale brown solid. The number average molecular weight (M_{w}), the polydispersity (M_{w}/Mₙ), and the yield of the polycarbosilane obtained are shown in Table 2.

TABLE 2

| | Reaction Solvent *¹ | Mₙ | M_{w}/Mₙ | Yield *² (%) |
|---|---|---|---|---|
| Example 2-1 | Toluene | 2.1 × 10³ | 2.2 | 52 |
| Example 2-2 | THF | 2.6 × 10³ | 1.2 | 14 |
| Example 2-3 | Hexane | 2.9 × 10³ | 1.6 | 64 |
| Example 2-4 | Diethyl ether | 2.3 × 10³ | 1.8 | 42 |

*¹ Anhydrous solvent
*² Methanol-insoluble component

According to Table 2, it was found that, when hexane is used as the reaction solvent in the polymerization reaction between 5,5′-bis(dimethylsilyl)-2,2′-bifuran and 1,5-hexadiene, polycarbosilane having ahigh number average molecular weight (Mₙ) can be obtained with high yield. It was also found that, when THF is used as the reaction solvent, a polycarbosilane having a low polydispersity (Mₙ/Mₙ) can be obtained.

### Comparative Example 1: Production of Single Furan Moiety-Containing Polycarbosilane

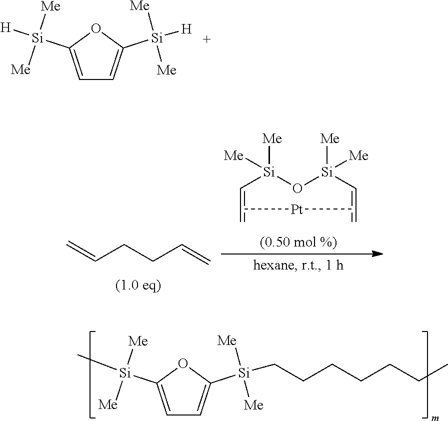

A single furan moiety-containing polycarbosilane was obtained in the same manner as in Example 2-3, except that 2,5-dihydrosilylfuran (1.0 mmol) was used instead of 5,5′-bis(dimethylsilyl)-2,2′-bifuran. The single furan moiety-containing polycarbosilane obtained had a number average molecular weight (Mₙ) of 4400 and a polydispersity (M_{w}/Mₙ) of 1.7, and showed a yield of 67%.

### Example 3-1 to Example 3-4: Study of Reaction Substrate

Polycarbosilane was obtained in the same manner as in Example 2-3, except that the compound (1.0 mmol) shown in Table 3 was used as the diene compound, and that the amount of hexane used was 0.3 mL. The number average molecular weight (Mₙ), the polydispersity (M_{w}/Mₙ), and the yield of the polycarbosilane obtained are shown in Table 3.

### Example 3-5: Study of Reaction Substrate (Study of Diyne)

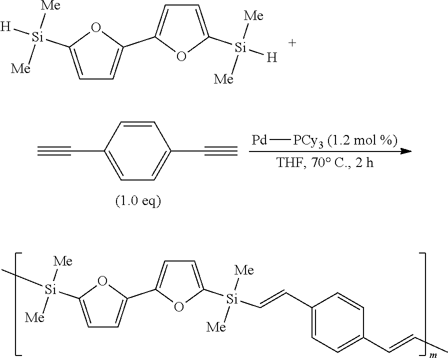

Pd₂(dba)₃ (11 mg, 12 μmol) and anhydrous tetrahydrofuran (0.62 mL) were placed in a two-necked recovery flask (25 mL) in which the atmosphere was replaced with nitrogen. Thereafter, freeze-pump-thaw was carried out. PCy₃ (4.1 μL, 24 μmol) was further added to the two-necked recovery flask, and the resulting mixture was stirred at room temperature, to synthesize Pd-PCy₃.

Subsequently, the 5,5′-bis(dimethylsilyl)-2,2′-bifuran (0.25 g, 1.0 mmol) obtained in Synthesis Example, 1,4-diethynylbenzene (0.13 g, 1.0 mmol), anhydrous tetrahydrofuran (0.65 mL), and Pd-PCy₃ (0.58 mL, 12 μmol) were placed in a Schlenk tube (30 mL) in which the atmosphere was replaced with nitrogen, and the resulting mixture was stirred at 70° C. for 2 hours. After the reaction, hydrochloric acid was added to the reaction mixture, and the resulting product was extracted with ethyl acetate. The solvent was distilled off from the obtained extract, to obtain a dark-red crude product in a liquid form. The crude product was added dropwise to methanol, to allow reprecipitation. The resulting precipitate was collected by filtration, and dried under vacuum at 80° C., to obtain polycarbosilane as a yellow-green solid. The number average molecular weight (M_{w}), the polydispersity (M_{w}/Mₙ), and the yield of the polycarbosilane obtained are shown in Table 3.

TABLE 3

| | | | M_{w}/ | Yield * |
|---|---|---|---|---|
| | Diene Compound | Mₙ | Mₙ | (%) |
| Example 3-1 | 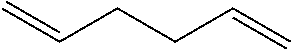 | 7.9 × 10³ | 1.9 | 79 |
| | 1,5-Hexadiene | | | |
| Example 3-2 | 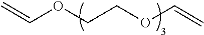 | 17.0 × 10³ | 1.3 | 32 |
| | Triethylene glycol divinyl ether | | | |
| Example 3-3 | 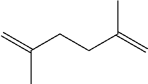 | 3.2 × 10³ | 1.6 | 39 |
| | 2,5-Dimethyl-1,5-hexadiene | | | |
| Example 3-4 | 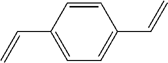 | 2.1 × 10³ | 1.9 | 21 |
| | 1,4-Divinylbenzene | | | |
| Example 3-5 | 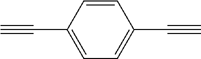 | 6.4 × 10³ | 1.8 | 41 |
| | 1,4 Diethynylbenzene | | | |

*: Methanol-insoluble component

### [Evaluation of Solubility of Polycarbosilane]

After adding 10 mg of the polycarbosilane obtained in Example 1 to 1 mL of the solvent shown in Table 4, the resulting mixture was stirred at room temperature or 50° C. Whether or not the polycarbosilane was dissolved was visually observed, and evaluation was carried out based on the following criteria. The results are shown in Table 4.

### Evaluation Criteria

++: Completely dissolved
+: Partially dissolved
−: Insoluble
n.d.: Not evaluated (complete dissolution can be readily expected)

TABLE 4

Temperature

| Solvent | Room temperature | 50° C. |
|---|---|---|
| Chlorofonn | ++ | n.d. |
| Chlorobenzene | ++ | n.d. |
| Toluene | ++ | n.d. |
| Diethyl ether | ++ | n.d. |
| Tetrahydrofuran (THF) | ++ | n.d. |
| N-Methylpyrrolidone (NMP) | + | ++ |
| Acetone | − | + |
| Dimethylformamide (DMF) | − | + |

From Table 4, it was found that the polycarbosilane obtained in Example 1 shows especially high solubility in halogenated hydrocarbon solvents, hydrocarbon solvents, and ether solvents.

### [Evaluation of Fluorescence Properties of Polycarbosilanes]

Each of the bifuran moiety-containing polycarbosilanes obtained in Examples 3-1 to 3-4 was dissolved in chloroform, to prepare a solution with a concentration of 10 μM as a UV spectrum sample, and a solution with a concentration of 1 μM as a sample for measurement of the fluorescence spectrum. The single furan moiety-containing polycarbosilane obtained in Comparative Example 1 was dissolved in chloroform, to prepare a solution with a concentration of 100 μM as a UV spectrum sample, and a solution with a concentration of 10 NM as a sample for measurement of the fluorescence spectrum.

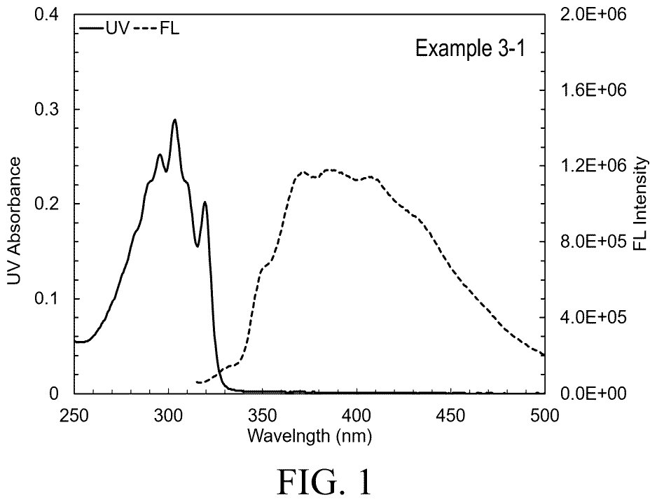

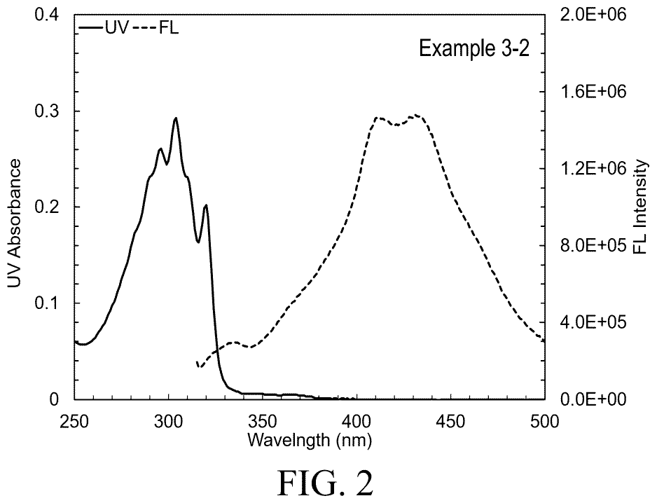

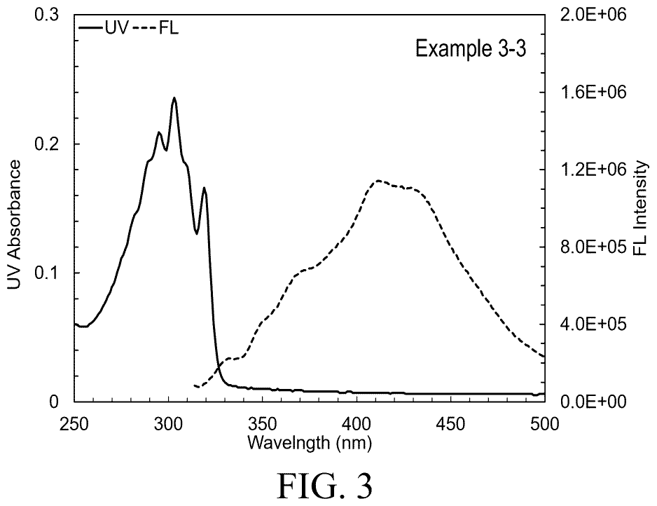

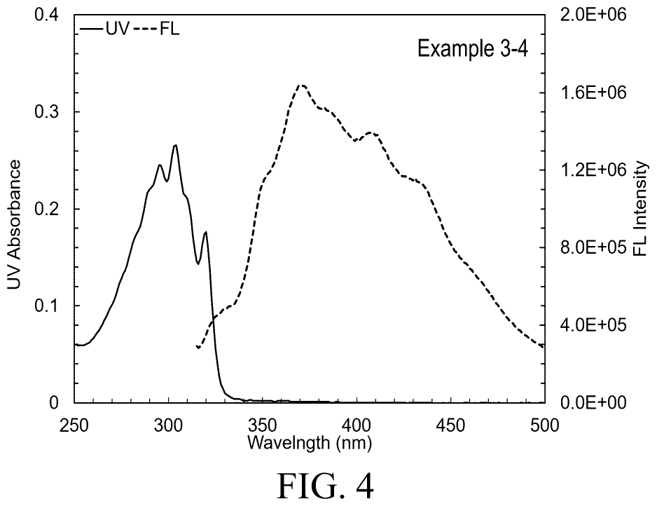

A UV spectrum and a fluorescence spectrum were measured using each of these samples. The results are shown in FIGS. 1 to 5. In each figure, the solid line represents the UV spectrum, and the dashed line represents the fluorescence spectrum. For the UV spectrum measurement, “UV, U-3000”, a UV/visible spectrophotometer manufactured by Hitachi, Ltd., was used. For the fluorescence spectrum measurement, “FluoroMax-4”, a spectrofluorometer manufactured by Kitahama Seisakusho Co., Ltd., was used.

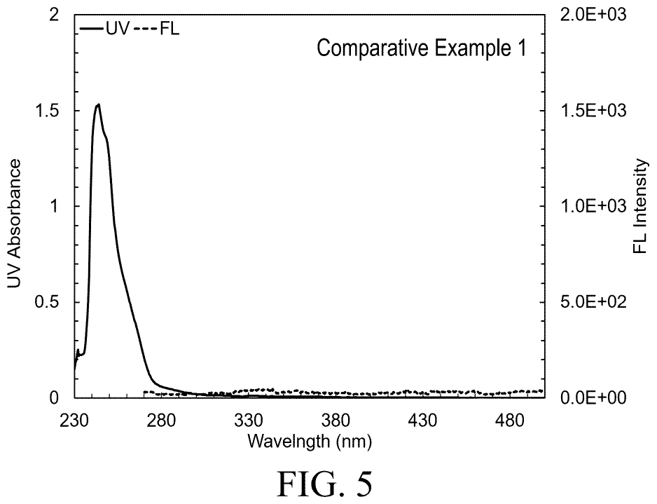

From FIGS. 1 to 4, it could be confirmed that each of the bifuran moiety-containing polycarbosilanes obtained in Examples 3-1 to 3-4 shows strong absorption near 260 to 330 nm, and strong fluorescence emission at 350 to 500 nm. On the other hand, from FIG. 5, it could be confirmed that the single furan moiety-containing polycarbosilane obtained in Comparative Example 1 shows strong UV absorption near 230 to 260 nm, which is a lower wavelength than that in the cases of the bifuran moiety-containing polycarbosilanes. It could also be confirmed that the single furan moiety-containing polycarbosilane obtained in Comparative Example 1 does not show fluorescence emission. From these results, the fluorescence emission behavior observed for the bifuran moiety-containing polycarbosilanes obtained in Examples 3-1 to 3-4 was due to the bifuran moiety.

### [Evaluation of Thermal Characteristics of Polycarbosilanes]

The 5% weight loss temperature (T_{d5}) of each of the polycarbosilanes obtained in Examples 3-1 to 3-5 was determined by thermogravimetry/differential thermal analysis (TG/DTA), and the glass transition temperature (T_{g}) was determined by differential scanning calorimetry (DSC). The measurement conditions were as follows. The results are shown in Table 5.

### Thermogravimetry/Differential Thermal Analysis (TG/DTA)

Polycarbosilane was placed in a ceramic pan, and measurement was performed using a Simultaneous Thermal Analyzer (STA-6000, manufactured by Perkin Elmer Inc.) under a nitrogen atmosphere (flow rate, 20 mL/min) at a heating rate of 10.0° C./min in a temperature range of 30° C. to 1000° C., to determine the 5% weight loss temperature (T₅).

### Differential Scanning Calorimetry (DSC)

Polycarbosilane was placed in an aluminum pan. Using a differential scanning calorimeter (DSC-4000, manufactured by Perkin Elmer Inc.), the glass transition temperature (T_{g}) and the melting point (Tₘ) were determined as follows. Under a nitrogen atmosphere (flow rate, 20 mL/min), the temperature increased from −60° C. at a heating rate of 10.0° C./min, and then maintained at about −30° C. for 5 minutes. Then the temperature decreased to −60° C. at a cooling rate of 10.0° C./min, and then maintained at −60° C. for 5 minutes. Then, the temperature increased to about −30° C. at a heating rate of 10.0° C./min.

TABLE 5

| | T_{d5} (° C.) | T_{g} (° C.) | Tₘ (° C.) |
|---|---|---|---|
| Example 3-1 | 392 | −17 | 62 |
| Example 3-2 | 322 | −46 | — |
| Example 3-3 | 365 | −37 | — |
| Example 3-4 | 361 | −18 | — |
| Example 3-5 | 429 | 80 | — |
| Comparative | 320 | — | — |
| Example 1 | | | |

From Table 5, it was found that all polycarbosilanes obtained in Examples 3-1 to 3-5 have 5% weight loss temperatures (T_{d5}) of not less than 300° C., indicating their high heat resistance.

On the other hand, the single furan moiety-containing polycarbosilane obtained in Comparative Example 1 had a weight loss temperature (T_{d5}) of 320° C., which is lower than the weight loss temperature (T_{d5}) of the bifuran moiety-containing polycarbosilane obtained in Example 3-1. This indicates that a bifuran moiety-containing polycarbosilane gives higher heat resistance than a single furan moiety-containing polycarbosilane.

Further, the polycarbosilane (Example 3-5) obtained by the reaction between the dihydrosilylbifuran compound and the diyne compound had a 5% weight loss temperature (T_{d5}) of not less than 400° C., showing excellent heat resistance.

The polycarbosilane derived from a diene compound obtained in Example 3-1 had a glass transition temperature (T_{g}) of not more than 0° C. However, since the melting point (Tₘ) was 62° C., it was solid. On the other hand, neither glass transition temperature nor melting point was found for the single furan moiety-containing polycarbosilane obtained in Comparative Example 1. It can thus be said that a polycarbosilane can be used as a crystalline polymer by the presence of a bifuran moiety rather than a single furan moiety.

The polycarbosilanes derived from diene compounds obtained in Examples 3-2 to 3-4 had glass transition temperatures (T_{g}) of not more than 0° C., and were in the form of rubbers at room temperature.

The polycarbosilane derived from a diyne compound obtained in Example 3-5 had a glass transition temperature (T_{g}) of 80° C. due to the stiffness of the polymer-main-chain.

### INDUSTRIAL APPLICABILITY

By the production method according to the present invention, an oligofuran moiety-containing conjugated polycarbosilane can be produced. The polycarbosilane not only exhibits fluorescence properties due to the conjugation, but also has heat resistance. Further, since the polycarbosilane exhibits solubility in common organic solvents such as halogenated hydrocarbon solvents, hydrocarbon solvents, and ether solvents, it is also applicable to wet processes such as inkjet method and spin coating. Thus, the oligofuran moiety-containing polycarbosilane can be expected to be applicable to σ-π conjugated organic semiconductor materials, engineering plastics, and the like.

1. A method of producing an oligofuran moiety-containing polycarbosilane, the method comprising:
a polymerization step of reacting a dihydrosilyloligofuran compound with a diene compound and/or diyne compound in the presence of a hydrosilylation catalyst,
wherein the dihydrosilyloligofuran compound is a compound having a 2- to 256-mer of a furan ring and a hydrosilyl group at the α-position of each of both terminal furan rings of the 2- to 256-mer of the furan ring.

2. The method of producing an oligofuran moiety-containing polycarbosilane according to claim 1, wherein the dihydrosilyloligofuran compound is represented by General Formula (A′-1): 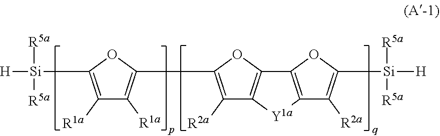
wherein R^{1a} and R^{2a} are each independently a hydrogen atom, a C₁-C₂₀ hydrocarbon group optionally having a substituent, or a C₁-C₂₀ hydrocarbonoxy group optionally having a substituent; when R^{1a} is the C₁-C₂₀ hydrocarbon group optionally having the substituent, or the C₁-C₂₀ hydrocarbonoxy group optionally having the substituent, the two R^{1a}'s bound to adjacent carbon atoms are optionally bound to each other through a direct bond or a linking group to form a ring; each R^{5a} is independently a C₁-C₂₀ hydrocarbon group optionally having a substituent, or a C₁-C₂₀ hydrocarbonoxy group optionally having a substituent; each Y^{1a} is independently —CH₂—, —CHR^{3a}—, —C(R^{3a})₂—, —PR^{3a}—, —S—, —O—, —Si(R^{3a})₂—, —NR^{3a}— or —C═C—; each R^{3a} is independently a C₁-C₈ hydrocarbon group; p is an integer of 0 to 256; q is an integer of 0 to 128; and p+2q is an integer of 2 to 256.

3. The method of producing an oligofuran moiety-containing polycarbosilane according to claim 1, wherein
the oligofuran moiety-containing polycarbosilane is a bifuran moiety-containing polycarbosilane, and
the dihydrosilyloligofuran compound is a dihydrosilylbifuran compound having a 2,2′-bifuran moiety and a hydrosilyl group at each of the 5-position and the 5′-position of the 2,2′-bifuran moiety.

4. The method of producing an oligofuran moiety-containing polycarbosilane according to claim 3, wherein the dihydrosilylbifuran compound is represented by General Formula (A-1) or (A-2): 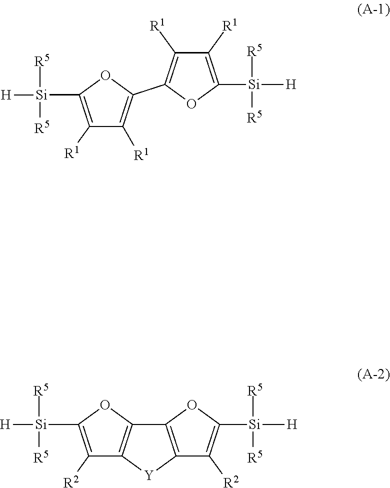
wherein R¹ and R² are each independently a hydrogen atom, a C₁-C₂₀ hydrocarbon group optionally having a substituent, or a C₁-C₂₀ hydrocarbonoxy group optionally having a substituent; when R¹ is the C₁-C₂₀ hydrocarbon group optionally having the substituent, or the C₁-C₂₀ hydrocarbonoxy group optionally having the substituent, the two R¹'s bound to adjacent carbon atoms are optionally bound to each other through a direct bond or a linking group to form a ring; each R⁵ is independently a C₁-C₂₀ hydrocarbon group optionally having a substituent, or a C₁-C₂₀ hydrocarbonoxy group optionally having a substituent; Y is —CH₂—, —CHR³—, —C(R³)₂—, —PR³—, —S—, —O—, —Si(R³)₂—, —NP³—, or —C═C—; and each R³ is independently a C₁-C₈ hydrocarbon group.

5. The method of producing an oligofuran moiety-containing polycarbosilane according to claim 1, wherein the diene compound is represented by General Formula (B): 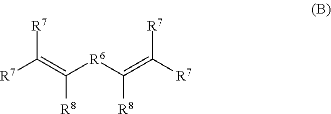
wherein R⁶ is a single bond, a C₁-C₂₀ hydrocarbon group optionally having a substituent, or —O(AO)ₙ—; AO is a C₁-C₆ alkyleneoxy group; n is an integer of 1 to 10; and R⁷ and R⁸ are each independently a hydrogen atom, a C₁-C₂₀ hydrocarbon group optionally having a substituent, or a C₁-C₂₀ hydrocarbonoxy group optionally having a substituent.

6. The method of producing an oligofuran moiety-containing polycarbosilane according to claim 1, wherein the diyne compound is represented by General Formula (C): 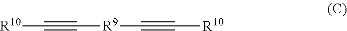
wherein R⁹ is a single bond or a C₁-C₂₀ hydrocarbon group optionally having a substituent; and each R¹⁰ is independently a hydrogen atom, a C₁-C₂₀ hydrocarbon group optionally having a substituent, or a C₁-C₂₀ hydrocarbonoxy group optionally having a substituent.

7. An oligofuran moiety-containing polycarbosilane comprising one or more of constituent units represented by General Formulae (D′-1) to (D′-8): 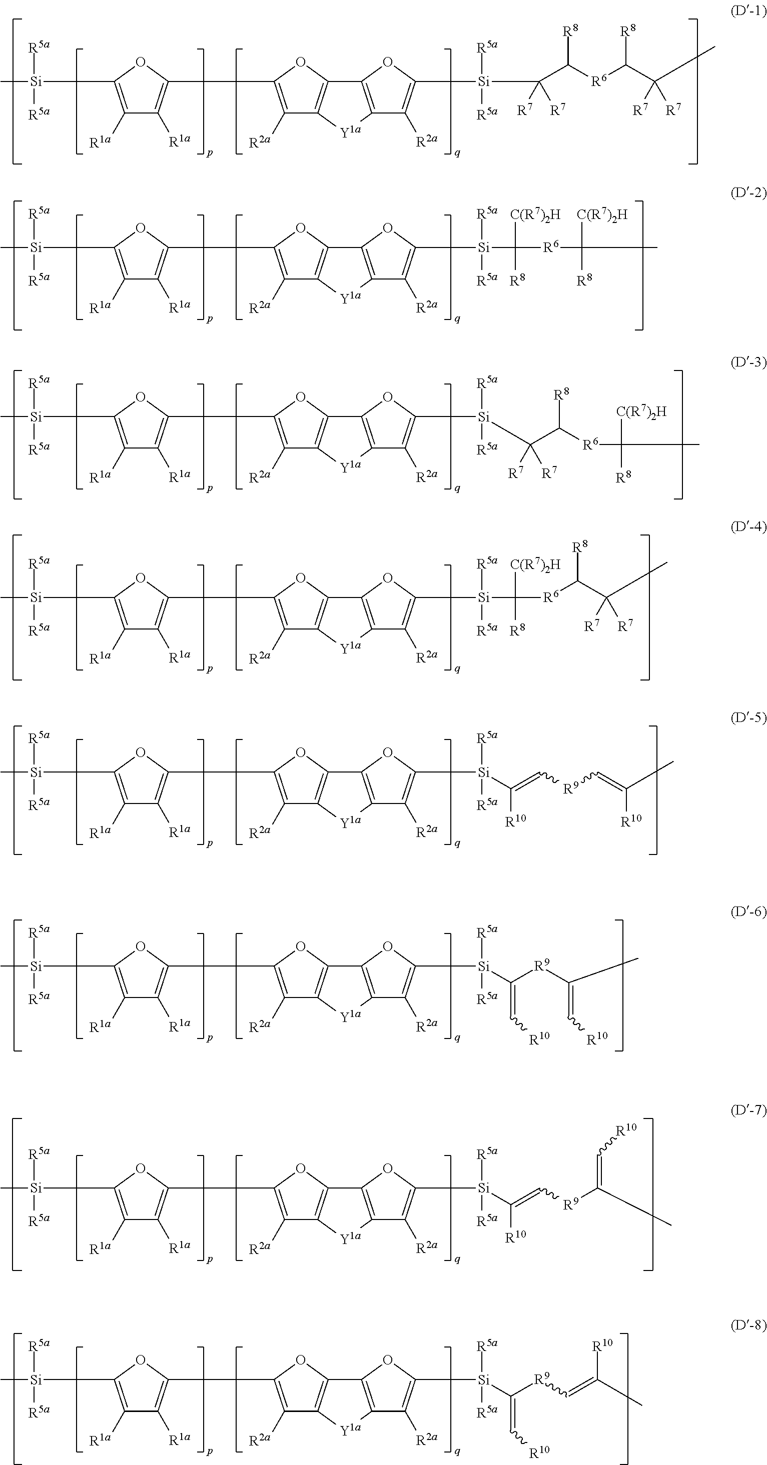
wherein R^{1a} and R^{2a} are each independently a hydrogen atom, a C₁-C₂₀ hydrocarbon group optionally having a substituent, or a C₁-C₂₀ hydrocarbonoxy group optionally having a substituent; when R^{1a} is the C₁-C₂₀ hydrocarbon group optionally having the substituent, or the C₁-C₂₀ hydrocarbonoxy group optionally having the substituent, the two R^{1a}'s bound to adjacent carbon atoms are optionally bound to each other through a direct bond or a linking group to form a ring; each R^{5a} is independently a C₁-C₂₀ hydrocarbon group optionally having a substituent, or a C₁-C₂₀ hydrocarbonoxy group optionally having a substituent; each Y^{1a} is independently —CH₂—, —CHR^{3a}—, —C(R^{3a})₂—, —PR^{3a}—, —S—, —O—, —Si(R^{3a})₂—, —NR^{3a}—, or —C═C—; each R^{3a} is independently a C₁-C₈ hydrocarbon group; p is an integer of 0 to 256; q is an integer of 0 to 128; p+2q is an integer of 2 to 256; R⁶ is a single bond, a C₁-C₂₀ hydrocarbon group optionally having a substituent, or —O(AO)ₙ—; AO is a C₁-C₆ alkyleneoxy group; n is an integer of 1 to 10; R⁷ and R⁸ are each independently a hydrogen atom, a C₁-C₂₀ hydrocarbon group optionally having a substituent, or a C₁-C₂₀ hydrocarbonoxy group optionally having a substituent; R⁹ is a single bond or a C₁-C₂₀ hydrocarbon group optionally having a substituent; and each R¹⁰ is independently a hydrogen atom, a C₁-C₂₀ hydrocarbon group optionally having a substituent, or a C₁-C₂₀ hydrocarbonoxy group optionally having a substituent.

8. A bifuran moiety-containing polycarbosilane comprising one or more of constituent units represented by General Formulae (D-1) to (D-16): 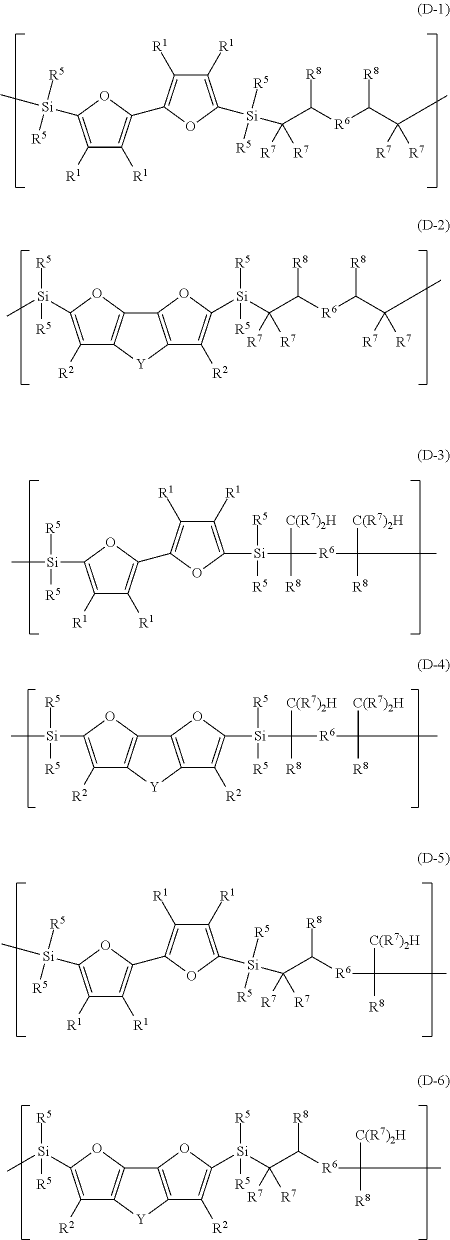 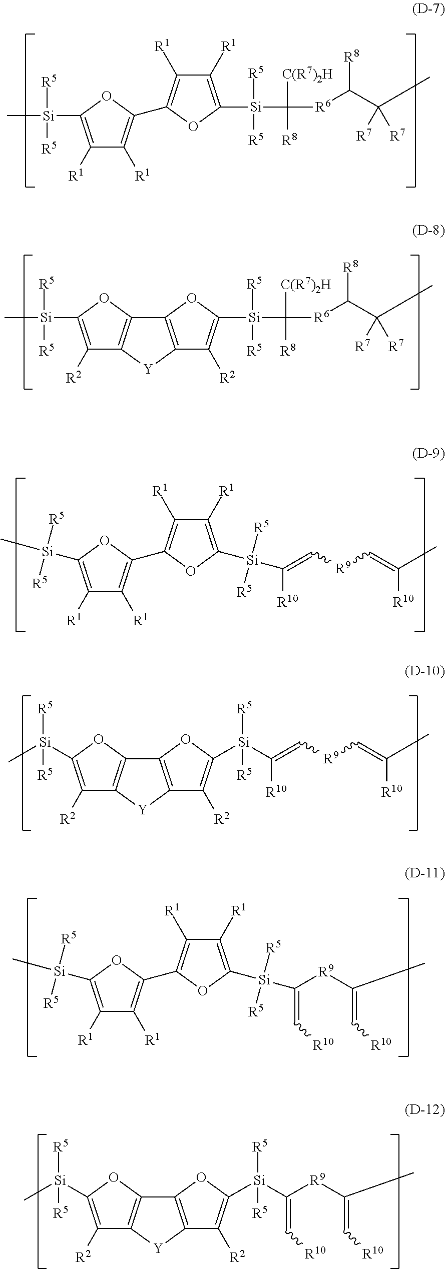 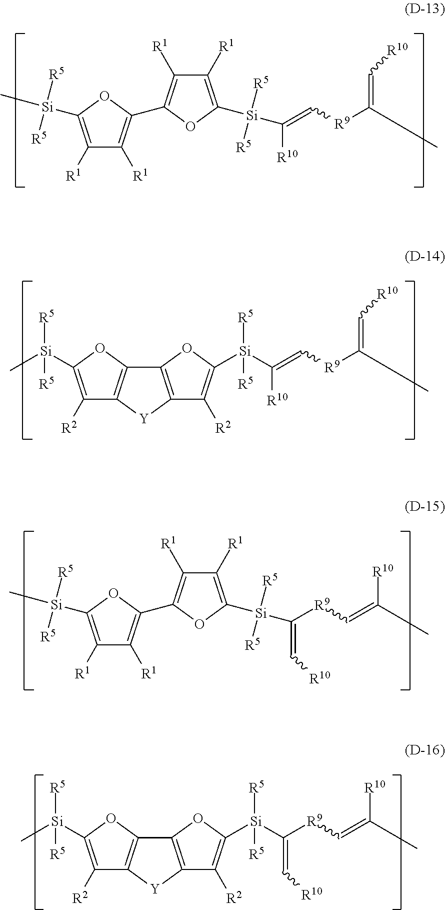
wherein R¹ and R² are each independently a hydrogen atom, a C₁-C₂₀ hydrocarbon group optionally having a substituent, or a C₁-C₂₀ hydrocarbonoxy group optionally having a substituent; when R¹ is the C₁-C₂₀ hydrocarbon group optionally having the substituent, or the C₁-C₂₀ hydrocarbonoxy group optionally having the substituent, the two R¹'s bound to adjacent carbon atoms are optionally bound to each other through a direct bond or a linking group to form a ring; each R⁵ is independently a C₁-C₂₀ hydrocarbon group optionally having a substituent, or a C₁-C₂₀ hydrocarbonoxy group optionally having a substituent; Y is —CH₂—, —CHR³—, —C(R³)₂—, —PR³—, —S—, —O—, —Si(R³)₂—, —NP³—, or —C═C—; each R³ is independently a C₁-C₈ hydrocarbon group; R⁶ is a single bond, a C₁-C₂₀ hydrocarbon group optionally having a substituent, or —O(AO)ₙ—; AO is a C₁-C₆ alkyleneoxy group; n is an integer of 1 to 10; R⁷ and R⁸ are each independently a hydrogen atom, a C₁-C₂₀ hydrocarbon group optionally having a substituent, or a C₁-C₂₀ hydrocarbonoxy group optionally having a substituent; R⁹ is a single bond or a C₁-C₂₀ hydrocarbon group optionally having a substituent; and each R¹⁰ is independently a hydrogen atom, a C₁-C₂₀ hydrocarbon group optionally having a substituent, or a C₁-C₂₀ hydrocarbonoxy group optionally having a substituent.
